(19) United States
(12) Patent Application Publication
(10) Pub. No.: US 2009/0050835 A1
(43) Pub. Date: Feb. 26, 2009

(54) Nozzles and Decorations or Ornamental-Functional Features

(76) Inventors: Wayne Scott Boise, Bel Air, MD (US); John Michael Fraund, JR., Baltimore, MD (US)

Correspondence Address: MAXVALUEIP CONSULTING, 11204 ALBERMYRTLE ROAD, POTOMAC, MD, 20854, US

(21) Appl. No.: 11/845,053

(22) Filed: Aug. 25, 2007

(51) Int. Cl. F16K 15/06

(52) U.S. Cl. 251/320

(57) ABSTRACT

There are two major applications here: Application 1: Balloon or toy filling device, with any other features besides the primary filling, dispensing, or balloon ridge or gripping features. Ornamental and ornamental-functional features are emphasized here, for example, use as a cover, protection, fitting, grip, handle, or hook (e.g. for hanging). Application 2: Method, system, and apparatus for balloon or toy valve actuated by (the force of) placing an object on the nozzle, or actuated at or by the nozzle egress, or using a one-handed operation means. Even though there are industrial valves out in the market place, there are none for water balloons, and none as easy to use, with one-handed operation, to be very practical and easy to use, by only one user (e.g. with one-hand push or pull operation, which is advantageous). The various variations and applications of each idea above are also discussed.

### RELATED CO-PENDING APPLICATIONS

This case is related to another divisional case, filed on the same day, with the same exact specification and assignee. It also relates to the following co-pending applications in US, with the same assignee:
application Ser. No. 11/557,116, filed Nov. 7, 2006.
application Ser. No. 11/539,830, filed Oct. 9, 2006.
application Ser. No. 11/539,813, filed Oct. 9, 2006.

All prior art and IDS of those cases apply here, as well. The teachings of those cases are incorporated herein, by reference.

### BACKGROUND

Some patents web sites and prior art links:
U.S. Pat. No. 5,439,199, with one of the water balloon filling valves/nozzles in the market.
Qualatex's U.S. Pat. No. 4,943,225.
U.S. Pat. No. 6,851,675.

Water Balloon Systems
www.watertag.com
www.waterblaster.net, for a portable filler.
www.waterballoonbattle.com and www.waterwars.com
Buzz Bee Toys www.buzzbeetoys.com/WWWaterFun/index.html
www.pitchburst.com—a type of water balloon dunking station, under U.S. Pat. No. 6,264,201.

Water Balloon Seals and Methods
Unique Industries www.favors.com sells Quick Knots under a design Pat. (D509725) and other patents, pending, for water balloon seal devices.
Patent application 20056176339: Balloon seal adhesive method
Z launcher and Z clips at www.zoosher.com, application numbers 20050188970 and 20050210639

Prior Art Valves Water Systems and Dispensers
U.S. Pat. No. 6,062,247
Toy sprinkler and toy fixture manufacturers such as:

www.toyquest.com with the Banzai brand

www.linkysprinks.com U.S. Pat. No. 6,561,810

www.aqualeisure.com various toy sprinklers with inflatable features and tubing.

www.aquastruct.com which is a patent-pending toy shower system.
Hose Clothes—www.moplants.com which is marketed as an ornamental cover for hoses.
Products for the lawn, garden, and irrigation market, such as: Gilmour, L. R. Nelson, Melnor, Orbit, Gardena, Hunter, Raindrip, and Dramm.
Ornamental toothpaste dispensers and patents such as U.S. Pat. No. 5,887,754.
Plumbing fixtures, faucets, and showerheads such as www.dripstop.com which has a valve designed to seal without washers.
Air pumps and helium pumps, as well as tanks and nozzles and other extension accessories.
Portable hydration or water filtration systems and accessories such as: Camelbak, Platypus, MSR, Katadyn, and General Ecology
Manufacturers of toy pistols, water guns, soakers, and various water backpack and hose or nozzle toy devices such as Fire Hose Hero.
Balloon stuffing machines such as www.balloonstuffer.com.
www.edarley.com—professional firefighting equipment such as nozzles and foam accessories.
Manufacturers of object inserting devices into consumer or industrial products such as chemicals, fertilizer and paint sprayers and car wash poles and soap.

Balloon Inflators and Pumps
There are many types of manual and electronic inflators as well as manual and electronic hand pumps in single or multi-nozzle systems for balloon inflation.
The prior art clearly delineates between those manufactured, marketed, and used for gas inflation (air, helium, air/helium mixture, nitrogen, or various nitrogen mixtures) and those used for fluid filling.
Balloons for gas applications are normally thick walled latex or foil balloons designed to prevent gas molecules from permeating the balloon wall over the course of time, since these balloons are generally used for display or other longer-term applications. Water balloons are typically thinner walled and designed to burst upon impact with an object for safety reasons and to be used in a relatively short time span after initial filling.
Some manufacturers of balloon gas inflation equipment are:
Cramer Decker at www.balloonfillers.com/products_gas.php
www.conwinonline.com
www.westwinds.com
www.fast-flo.com
www.magmover.com
www.coolaire.com
Some balloon inflator/inflation valve patents:
U.S. Pat. No. D488388, U.S. Pat. No. D333664, and U.S. Pat. No. D325586
U.S. Pat. No. 7,147,016, U.S. Pat. No. 6,790,120, U.S. Pat. No. 6,634,394, U.S. Pat. No. 6,488,557, U.S. Pat. No. 6,042,448, U.S. Pat. No. 5,934,310, U.S. Pat. No. 5,879,219, U.S. Pat. No. 5,653,272, U.S. Pat. No. 5,651,402, U.S. Pat. No. 5,588,896, U.S. Pat. No. 5,496,203, U.S. Pat. No. 5,199,847, U.S. Pat. No. 5,188,558, U.S. Pat. No. 4,921,402, U.S. Pat. No. 4,721,491, and U.S. Pat. No. 4,560,392. Most of these above mentioned patents relate specifically to innovations in the gas balloon nozzle or nozzle system functional area only, and do not discuss or disclose any relation or reference to the water balloon nozzle market.
Others: U.S. Pat. Nos. 6,112,781, 5,603,361, 4,243,220, 6,851,675, 6,932,125, 4,909,510, and 6,149,488.

However, none of the above teaches the features of our invention, shown below.

### SUMMARY

Here, we have a system and method for balloon or toy filling (inputting) device and accessories (as well as, gluing, sealing, or tying objects, methods, devices, and accessories), manufacturing machines and molds, sales methods and media, retail displays, and various kits.

This also relates to our previous application with multi-nozzle systems. This current application targets mostly single nozzle systems, but both applications interrelate and can benefit from each other. That is, they can be combined.

There are 2 major applications here:

Application 1: Balloon or toy filling device, with any other features besides the primary filling, dispensing, or balloon ridge or gripping features. Ornamental and ornamental-functional features are emphasized here, for example, use as a cover, protection, fitting, grip, handle, or hook (e.g. for hanging).

Application 2: Method, system, and apparatus for balloon or toy valve actuated by (the force of) placing an object on the nozzle, or actuated at or by its egress, or using a one-handed operation means or one or more fingers. This is an extremely important invention, even though there are industrial valves out in the market place, there are none for water balloons, and none as easy to use, with one-handed operation, to be very practical and easy to use, by only one user (e.g. with one-hand push operation, which is advantageous).

The O-ring and membrane on the sides of the nozzle keep the fluid intact. The tip can be pushed in/out to close/open the flow, respectively. One can have multiple devices in parallel. One can have another regular valve in series. The tip can be rotated in and out similar to a screw, with grooves on the sides. Furthermore, the grooves have holes which get aligned with the other holes, in the supply line/center/shaft, to let the fluid pass. The nozzle may or may not have the stop mechanism, to stop the flow.

This applies to filling, sprinkling, spraying, squirting, etc. It is not just the act of filling an object, but also the possibility that the system can be used to simply dispense fluids or other objects in one or more ways. It applies to the display, kit, stuffing, and manufacturing or product molding. This applies to ornamental, aesthetic, or play components. It can be used for air, water, helium, and mixed gas balloon nozzles and systems.

Other features and other embodiments, examples, or variations:
Manufacturing molds and forms and methods for geoshape nozzles, or nozzles that have ornamentation.
Marketing or sales methods, or retail product shelf placement of ornamentation products, for example, for holding, placement, or hanging, as a means of utility.
Enhance the fluid and mechanical engineering, hydrostatics, and other physics aspects.
Expand scope beyond water balloon nozzles.
New product line families, such as moving parts, see-thru, extensions, electronics, etc.
Method of filling more water balloons in a given time. More efficient method.
Kits, including kits for adding anything to prior art nozzles, such as stickers.
A nozzle with its egress above the filler source, or any other direction besides downward.
Structures, methods, business methods, processes, machines, software, and chemical compositions, for nozzle, accessory, manufacturing mandrels and molds, manufacturing, sales methods, user filling processes, machines to manufacture, nozzles with machines and software, to design, use, or sell, and compositions of matter, with unique plastic/metal and other characteristics.

For this application, any term such as nozzle, valve, filler, funnel, loader, quick-fill loader, sweeper, shutoff, coupling, shutoff coupling, Y-valve, 2-way or 3 way or more way, splitter, manifold, faucet, bib, hose, spigot, portable filler(s), and other related terms are included in the coverage of the patent.

For this application, any term such as hose, hose extension, extension, faucet extension, soaker hose, standard hose, coiled hose, flat hose, weeper hose, washing machine hose or other type of non-gardening plumbing hose, irrigation hose, tube, tubing, pipe, piping, conduit(s), no-kink, or no-kink extension are included in the coverage of the patent.

The water balloon market also has various water receiving objects. For this application, balloon, water balloon, water bomb, water grenade, water balloon rocket, water rocket, and other related balloon objects are included in the coverage of the patent. Another type of a water bomb is paper that is folded to form a roughly spherical receptacle such as origami. The application does not limit the invention use to just water balloons, but also envisions its use for other water toys, toys, and other objects which may be filled or partially filled with any solid, liquid, gas, or combination of one or more of those.

For this application, the ornamentation may also have one or more functional improvements, design enhancements, moving parts, licensed characters, accessories, additions, aesthetic features, electronic features, color variations, see-through components, screens or filters, material variations, molding variations, kits, informational features, play components, or removable parts.

There are various devices and methods common in the prior art to seal objects, particularly involving a fluid medium and a related conduit or conduits. For this application, the terms seal, washer, o-ring, gasket, screen, filter, and other related terms are all included, with and without thread engagement features.

Common terms used in the balloon industry to indicate balloon expansion are inflate or inflator or inflation (used for gas balloons), and fill or filling or load or loader (used for water balloons.) There may be other terms used, and these are not necessarily mutually exclusive. Some nozzles and systems are designed for either gas or water applications. The words pump or hand pump are usually used for gas systems in mechanical or electronic versions, but this application also references the types of pump for water balloon nozzle systems.

The terms fluid, liquid, and gas are all included here, as well as different temperatures and pressures.

### BRIEF DESCRIPTION OF THE DRAWINGS

FIGS. 1-3 show a design of a nozzle with a non-visible on/off means and a multi-conical profile.

FIGS. 4-7 show an ornamental design of a nozzle without an on/off means. The toy or object attached on the nozzle or manufactured on the nozzle can act as a handle for better grip as well. It can be used as a hook to hold or position the hose or nozzle. It can be soft. It can be rigid. It can be removable. It can be stationary. It can be exchangeable with other objects to make it more fun for the user. It can be made of Velcro or similar objects for attachment to other objects.

FIG. 8 shows a design of a nozzle with on/off means.

FIGS. 9-12 show various designs and profiles of prior art nozzles which show externally viewable on/off means.

FIG. 13 shows a prior art nozzle without a shutoff means.

FIG. 14 shows the prior art Quick Knot and Tye-Dye balloon which can also be part of a kit with the inventions.

FIG. 15 shows a prior art shutoff coupling with swivel turn source attachment means and a viewable on/off means.

FIG. 16 shows a prior art zinc shutoff coupling with a viewable on/off means.

FIG. 17 shows an extension above source ingress with decoration. It uses a prior art nozzle and shutoff coupling also with decoration. This example is using PVC for the extension.

FIG. 18 shows a threaded extension or other accessory with ornamentation and without an attached prior art nozzle.

FIG. 19 shows extension with swivel nut and integrated nozzle and decoration.

FIG. 20 shows an integrated extension nozzle with moving and floating parts and see-through mechanism. It also has one or more internal screens to let fluid pass while maintaining the moving and floating parts in the desired internal space.

FIG. 21 shows an ornamental nozzle.

FIG. 22 shows a prior art nozzle with ornament on multiple surfaces including the interior and exterior surfaces and the on/of means.

FIG. 23 shows a prior art nozzle with user attachable ornamentation kit with multiple pieces.

FIGS. 24-26 show some ornamental designs.

FIG. 27 shows a nozzle extension and/or cover with an on/off means and swivel source attachment means.

FIGS. 28 and 29 show some designs with a raised circular surface accessory or object attachment means in a front and back view. It may be used for a balloon tying or sealing means or attaching a balloon tying or sealing device or a balloon storage device or other device. The same raised circular surface may also show a means of actuation or be used for other purposes. It may comprise one or more shapes or be fixed or adjustable all or in part. It may rotate or move all or in part.

FIG. 30 shows valve closed.

FIG. 31 shows valve open. There are four protrusions that stick out of the valve body facing away from the spigot. Those are springs that move down the angled inside surface of the shut off component. When the valve is actuated they flex inward toward each other and, when the balloon is filled, the water pressure and the forces from those springs trying to return to the normal state shut off the valve. There may be one or more protrusions or other means.

FIGS. 32-35 show some designs in front and back sections. FIGS. 32-33 show a front view of the nozzle and FIGS. 34-35 show a back view of the nozzle. The connection means for the two pieces are shown and the housing for the valve means.

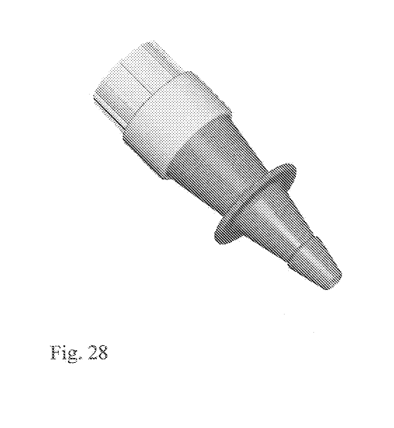

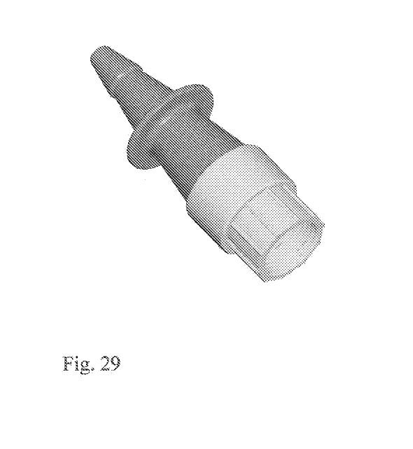

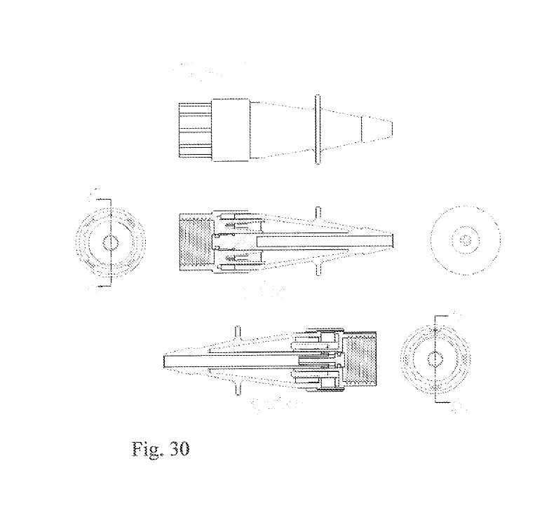

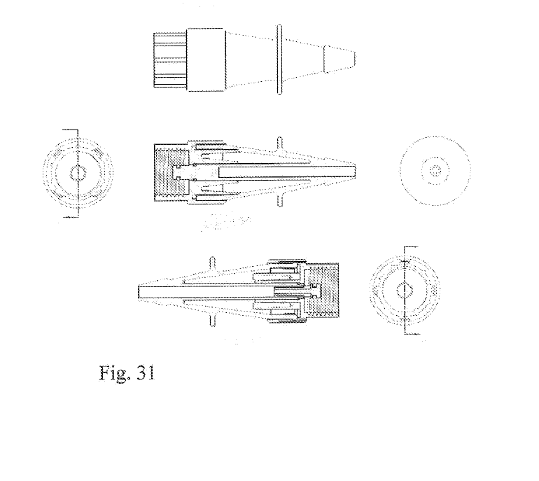

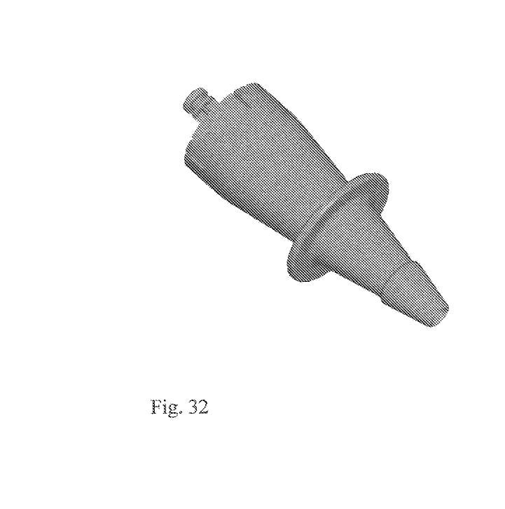

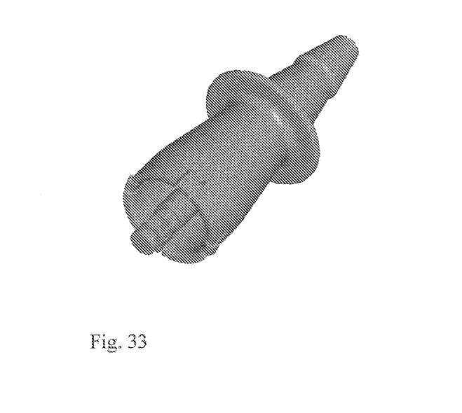

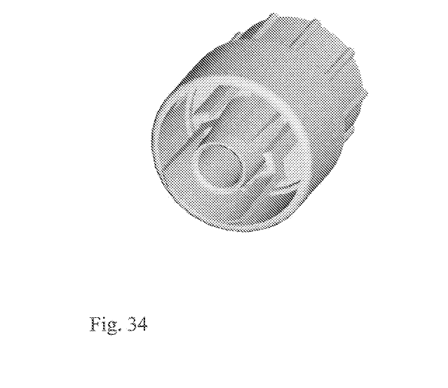

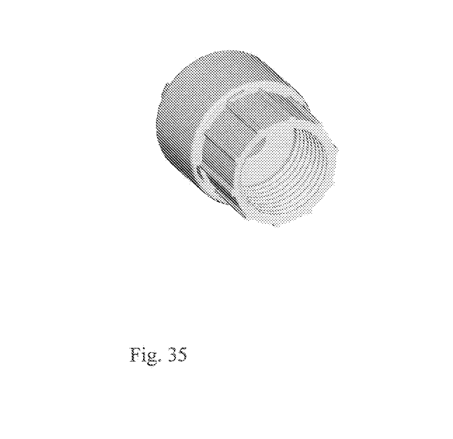

(In FIGS. 28-35 as in all figures, the sizes of the components may be variable with respect to each other or as shown or any combination thereof. That is, the sizes or dimensions shown are just examples, and the invention is not limited to that.)

### DETAILED DESCRIPTION OF THE PREFERRED EMBODIMENTS

Problems with Prior Art or Adaptations to New Markets

The invention overcomes many limitations in the prior art for water balloons nozzles, kits, and accessories. It is felt that by addressing these issues, water balloon and water balloon nozzle sales would dramatically increase, and that is an objective of the embodiments of this invention.

Prior Art Limitations Overcome by this Invention, or New Features and Advantages:
Excess Water Use—Water is becoming increasingly more expensive and scarce in many regions of the world which makes its conservation through enhanced nozzle design a paramount concern. Wasting water through inefficient on/off mechanisms, or designs that are difficult to use with balloons, contribute to wasted water. Many nozzles do not have a shutoff feature and the remainder of the nozzles on the market use a difficult two-handed valve operation means.
Environment—Recycling continues to grow in popularity and will continue to grow in importance as societies struggle with waste and garbage disposal costs. Consumers are also becoming more savvy and interested in buying products that are more environmentally conscious, which is the case here.
Balloon stuffing—Balloon stuffing technology has not been adapted for water balloons, but has only existed in air and helium balloon until this invention.
Backcountry or other extreme or isolated environments—Attached or portable fillers are still designed for relatively urban, suburban, or rural environments. No nozzle has specifically targeted environments far away from civilization where an individual must pack in and pack out all materials and be cognizant of weight issues, until this invention.
Sales methods and packaging—Until this invention, the primary focus of the balloon industry was on water balloons, and not nozzles. This is a backwards strategy that has stymied innovation and the very growth in balloon sales that is sought. It has also new uses for the product to various other toy or non-toy uses that can be marketed. This invention is also the first to package and create retail displays and other promotional material or sales training for specific types of water balloon nozzles as envisioned in the invention.
Ornamentation—Until this invention, no consideration of the fact that the water balloon nozzle products are primarily targeted to children has gone into the R&D for designing products that appeal to children as well as incorporating other toy-like features, for appearance and/or functionality.
Aesthetics—Until this invention, no water balloon nozzle product has been designed that would be visually appealing to remain as a permanent fixture or seasonal or semi-permanent fixture. This industry needs to evolve as has the lawn and garden industry with functionally-ornamental products. Aesthetics also serve a market need of product differentiation for consumers that want to buy a mid-level or higher-end product.
User productivity—Prior art water balloon nozzles have various designs which inherently limit user productivity and/or possible quantities attainable in a given amount of time. The quantity and access needs of groups, in particular, are largely unmet in the prior art, but are solved by this invention.
Balloon sealing—Various sealing methods exist in the prior art for water balloons, but none are integrated with the nozzle or a nozzle accessory as with this invention.
Access—For a situation with a fixed and low location of a hose bib, this creates access issues that are overcome by this invention, especially by integrated or non-integrated extensions, as well as other means.
Group interaction and play value—A solely functional and single access nozzle leaves many participants with nothing to do except wait for a filling turn. This invention creates an inviting filling area and one that is more conducive to group gatherings.
Ease of shutoff use—Prior art nozzles either have no shutoff capability or one that is not designed specifically with the best interests of water balloon filling in mind. This invention creates a nozzle that is easier to engage and disengage the shutoff feature.
Ease of device attachment—Prior art water balloon nozzles are designed with threading or the lack thereof. Additional ergonomic or attachment features that are common in the gardening industry are lacking in the water balloon nozzle industry until this invention.
Kits, games, and/or arts/crafts—The prior art is full of various kinds of kits, but there are few water balloon kits with game or activity instructions, and none that provide a user with tips and ideas for running events or parties or include other media or arts and crafts products or projects and components until this invention.
Solids—This invention is the first to use solids in a water balloon system.
Mixed properties—This invention is the first to use a mixture of a solid with a liquid and/or gas in a water balloon system. And/or, to combined a liquid and gas in a water balloon system.
See-through parts—Many valves have a see-through part or parts that are designed for various functions, but there are none in the water balloon industry for either functional or non-functional purposes until this invention.
Attachable/Detachable parts or objects—Some valves, including water balloon valves, have functional parts that can be removed for maintenance or use such as an O-ring, but there are no water balloon valves that have parts that can be attached or detached that are not specifically designed for the water dispensing or sealing functions until this invention. This invention is also the first to have ornamental parts.
Value—Prior art water balloon nozzles are sold at higher margins when compared to gardening nozzles that may come with more advanced features. This invention seeks to introduce multiple innovations into the water balloon industry in order to reduce the cost of nozzles to the consumer, while simultaneously increasing product quality, durability, and consumer expectations of value. Manufacturing profits will increase as consumers buy multiple nozzles with various ornamental or functional components and it is possible for even higher margins to be obtained in this manner.
Price-versioning—Prior art water balloon nozzles are designed with a one size fits all mentality. A consumer must have chosen between a nozzle without a valve at price point ‘X’ and a nozzle with a valve at price point ‘Y.’ This invention creates multiple new price point possibilities and widely expands the range of features available to consumers. It also challenges the existing price points.
Color—Prior art water balloon nozzles are made with either one or two plastic resin colors. Some also have various single-colored seal devices. No prior art nozzle until this invention has a water balloon nozzle with three or more plastics or exterior conduit colors possible, or multi-colored seal devices possible.
Reuse—Most prior art water balloon nozzles are designed for single use or disposability. This invention covers water balloon nozzles designed and/or promoted for multiple uses and sold with or without balloons.
New uses—Most prior art water balloon nozzles are designed and/or promoted for water balloons only, but the addition of other features open these nozzles up to a wide variety of indoor and outdoor uses.
Collectible—Some prior art water balloon nozzles are functionally designed and intended to be disposable. However, many toys are collectible items and innovative new water balloon nozzle designs should be, as well, either individually or part of a series. This invention embodies licensed products and other types of product lines and extensions.
Targeting—Most innovative prior art balloon nozzles are made for the gas inflation market and those products are mostly targeted to rental companies, retail party stores, commercial markets, and various types of balloon professionals and entertainers, instead of the mass consumer market. While some of those innovative features may be adaptable to water balloon nozzles, there are many differences in technology and use that this invention overcomes, as well as new features enabled by system inputs and/or outputs.
New business—There are companies in the balloon industry that are primarily focused on gas inflation equipment. There are no companies in the balloon industry solely focused on water balloon nozzles, but that is now possible with the multiple innovations in this invention which create a wide range of differentiated products. This invention also hopes to spur new business opportunities for professionals that are now limited by the lack of innovative water balloon filling technology. This invention will even encourage the formation of businesses that fill water balloons for sale to other consumers.

These categories are described in more detail in the following bulleted sections:

IYC Products LLC, founded by the inventor (though product development was many years prior to company formation), is the first business to be focused on inventing, prototyping, producing, marketing, packaging, and/or licensing water balloon nozzles and/or related nozzle accessories. Most other manufacturers are trying to sell water balloons and water balloon nozzles together, but IYC Products LLC wants to focus on water balloon nozzles primarily. This invention claims new methods of doing business focused on water balloon nozzles and its accessories and systems. This further suggests that many manufacturers are not focused on single nozzle balloon systems, let alone water balloon filling systems. Several of the new business method categories include ornamental water balloon valves, and a one-handed operation water balloon valve.
Cramer-Decker, Conwin, Westwinds, Fast-flo, Magmover, Coolaire, and other inflation equipment manufacturers target the gas balloon market. These companies mostly focus sales and marketing efforts toward the professional retailer or balloon professional market. The only ornamentation apparent in the gas nozzle industry is limited use of color and some ornamental helium cylinder tank covers. These inflation products are priced for professionals when similar technology exists in air compressors and patented helium inflation party kits such as www.balloontime.com, targeted at the consumer market for much less. Balloontime does not have an ornamental nozzle. While some manufacturers of gas inflation equipment have various tilt valves or push valves or foot valves that allow users to inflate with one hand or to use two hands to inflate two balloons on different nozzles, this equipment is technologically different from that required for liquid applications for the water balloon market. Most gas inflation equipment is made with higher tolerances necessary to keep and move gas molecules within the system, when compared to lower tolerance needed to maintain a liquid within a water balloon system. Most gas inflation nozzles are made of brass or other metals which differentiate from the plastics used with consumer water balloon nozzles (some professional slingshot and other rental devices use some metal components in water balloon nozzles.) Some gas inflation systems use a rubber or flexible nozzle that may or may not be used for a pressurized water system. Gas balloon nozzles may be sized or structured to optimize foil balloon filling or latex gas balloon filling and not for water balloon filling, which requires the unit to hold a greater weight and perhaps for a longer period of time. The threading or connectors used for inputs or outputs to the system are different than those used in water balloon nozzles and vary greatly when worldwide standards for piping and/or safety for gas or water technology are considered. Pistons are commonly used on gas inflation systems, and not on water balloon systems. Flow regulators and pressure valves and mixers and contents gauges are usually used on gas inflation systems and not on water balloon systems, until this invention, but still regulate and measure and mix and describe in different ways related to the system input and output. There are numerous other parts that are required for a gas system that are not necessary for a liquid system. Typically, electronics or batteries or motors are used in gas system, but not in water balloon systems until this invention. Tie hooks and seal device areas or connection means are common on gas inflation systems, but not on water balloon systems until this invention. An external pressurized gas source or pressurization means or cylinder is required for gas systems, but not for water balloon systems, until this invention. Gas systems typically require safety instructions for the use of pressurized gas sources which were not necessary with water balloons, until this invention. Gas systems may have extension valves or hoses that were not envisioned for water balloons, until this invention. Most gas system nozzles are positioned upwards or sideways and rarely downward, as most water balloon nozzle installations, and are consequence of the physical properties of the system input/output of a gas, versus a liquid. This invention addresses those excessively limiting barriers by proposing multiple new system designs. Many gas systems have an almost infinite number of valve positions whereas most water balloon nozzles with a stop feature are either on or off without any other settings until this invention. Many gas systems allow for more than one type of gas input whereas prior art water balloon systems commonly are hooked up to a pressurized water source exclusively until this invention. Some gas balloon systems have an automatic shutoff feature designed to prevent overfill of a balloon and/or prevent balloon bursting during the fill process and this feature is not in prior art balloons until this invention. Most gas systems are designed with a base or feet or other means to sit on the ground or a floor or desk or counter or other surface whereas water balloon nozzles were never designed for those purposes until this invention. Gas balloon systems may have a carrying case or storage means which were not available for water balloon systems until this invention. Gas balloon systems may have removable or interchangeable or separate nozzles in its systems whereas water balloon nozzles are made with one output and conical shape until this invention. Gas balloon systems such as Twist-N-Flate have optional shoulder or waist mount versions, but no such mounting means are available in water balloon nozzles until this invention. Some gas balloon systems have a balloon basket or pre-filled balloon storage means, but no means exists for water balloon nozzles until this invention. There are other differences, too.
Camelbak, Platypus, MSR, Katadyn, and General Ecology, and other manufacturers have hydration systems and/or water filtration systems for the athlete or outdoor enthusiast market. Hydration systems use various water dispensing methods with bite valves being the primary means. It uses flexible tubing and a flexible valve attachment means. An accessory includes a flexible positioning device that goes over the tubing. Many balloon filler designs are portable, but either lack size or are poor quality. Many hydration systems are extremely sturdy and, with the right adaptor, be used as a portable water balloon filler. Biodegradable balloons are also lightweight and could be a fun outdoor activity even in remote wilderness country. Even solar shower systems could be used with similar results. Many portable water filtration devices are sturdier than portable water balloon filling devices and could be used or modified for filling water balloons. The technology used in this industry is adaptable to new uses in the water balloon nozzle industry, particularly when it comes to portable filling, tubing and flexible tubing, covers and flexible positioning devices, and flexible valves, among other innovations.
Most water balloon nozzles on the market are made of various plastics or various resin compounds and some utilize O-ring washers or gaskets, either standard or custom in size or design. Water balloon nozzles are inexpensive to make, but sold at very high margins while also designed as a mass market disposable product which is contradictory from a consumer vantage point.
The U.S. Pat. No. 5,439,199 patent by Pioneer (www.pioneernational.com) is the best water balloon valve on the market (and the only one with an issued patent), but it also has some limitations. In its most common and logical use, it still requires two hands, one to hold the balloon and another to operate the stop, else the user must remove the balloon and press the stop feature while allowing water to escape in a one-handed filling attempt. Like all other water balloon nozzles, it is designed solely for function and not ornamentation which may or may not include additional functions. Kids like creative designs and these designs can be produced and sold for less than current manufacturers charge for existing designs whether sold individually or as a kit with balloons and other products. The '199 push/pull up/down stop is the only easy to use product on the market. However, threading a valve onto a faucet or hose or spigot sometimes puts the valve stop in a harder to reach location than is ideal (bottom, sideways, etc. instead of on top) and such is the case with the '199 product. Other non-Pioneer stops such as the turn handle or the push through pin are very hard to use as are the fillers without a stop mechanism (Pioneer has one) and requiring a further reach to a shutoff valve/coupling and additional cost or the arduous task of reaching for the hose bib or faucet handle. This '199 valve also has balloon gripping ridges on the shaft. These have the benefit of helping hold the balloon while filling, but may be tough for some to pull back off with a nearly filled water balloon. Many times the balloon breaks or the water is lost because many brands of balloons are either poorly designed or designed with low stress resistance to breaking, for, after all, water balloons are supposed to break. Additionally, the balloon has to be sized for the exact shaft location and there are only two on the shaft. There are many other sizes of balloons on the market.
The nozzles by Imperial Toy (www.imperialtoy.com) have one or two colors, a turn handle, and on/off direction printed on the nozzle. The on/off indicator is helpful, but is difficult to read or understand since it is molded in the same color as the nozzle. The turn handle is very difficult to operate since the stop mechanism inside rubs frictionally against the unit. This nozzle requires lubrication and re-lubrication, but that is not mentioned on the instructions. This nozzle also has one balloon gripping ridge. Some of these nozzles come with severe plastic defects at the gripping ridge resulting in balloon damage and an unsightly and uncomfortable nozzle. This may be a result of removal from the mold at manufacturing or some other issue, but has had serious implications in the filling process. Imperial sells neon-colored water balloons in a kit with a two-colored neon nozzle. Imperial also sells color-matched nozzles and balloons in semi-rigid plastic tubes under the Team Tubez brand and also private labels which are a packaging innovation compared to other manufacturers. One of the problems with water balloons is keeping track of them during use and this hard tube with its own cap feature goes a long way toward that goal, but it still does not provide a means to attach or easily access the balloons near the nozzle or on the nozzle. One major problem for this packaging at retail is the flexible tape used to secure the nozzle cover area to the main part of the tube. It rips off very easily or consumers pull it off to examine the nozzle or perhaps even to steal the nozzle. Regardless, many stores have had balloons and packaging parts all over the shelves and aisles as a result of this packaging. Imperial also makes a product called “Ultimate Battle Bucket” which is a kit with 750 balloons, two balloon nozzles, and multiple other items.
The push through valve by type by Excite and others is also very difficult to operate and includes two gripping ridges in seemingly exact visual proportion to Pioneer. This valve also requires lubrication and re-lubrication, and similarly does not explain that on the instructions. Typically, teenagers or adults (and not young children) would have the manual dexterity and strength to operate these types of nozzles and a proportion of them would figure out to lubricate the system prior to use. However, since the instructions do not indicate this point, many users may not have access to lubrications at the scene or time of use.
Unique Industries and many other manufacturers do not have a nozzle with a shutoff mechanism and rely entirely on the water source valve itself or another means which is difficult and puts wear and tear on the valve integrated into the building or facility or the part being used. Unique markets some water rocket balloons and other innovative products, but needs to compete in the nozzle segment. Its water balloons are among the best in the industry however from a price/quality/quantity ratio. However, some other manufacturers tend to have a retail sales price point in mind and a quantity of balloons to go with that. To squeeze out greater margins, manufacturers sometimes increase the quantity of balloons, but decrease the size of the balloons. Most end-users have a difficult time tying smaller sized water balloons and get frustrated or give up after a few attempts rendering the product ineffective and repeat sales unlikely.
Some other manufacturers of generic water balloon nozzles include Boss Balloon Company and CTI Industries. CTI markets the Party Loons brand with neon balloons and a patriotic theme of individual red, white, and blue balloons. The nozzles are uni-color however.
In general, all water balloon nozzles are designed to thread onto a faucet or hose bib. For young children or those with disabilities this attachment may be difficult to accomplish without adult help or supervision.
The No-Knot Water Balloon Filler with self-sealing valves are no longer on the market. The valves are difficult to operate for young children and the expansive system did not help its market acceptance. Overall, the industry has tried to innovate portable systems over the past few decades and has neglected non-human pressurized systems such as municipal water supplies. This tragic R&D and marketing blunder has resulted in millions of dollars of lost revenues and a consuming public missing out on new products for the more mainstream uses at the home or backyard, for example.
The main problem with Water Wars and Water Balloon Battle is the high cost and the fact that it only targets the commercial amusement park or party/event planner market. Again, these are good ideas that have fundamentally missed the mass market applications of the toy industry and water balloon desiring public to have more access.
Several retailers and distributors such as KB Toy Holdings sell water balloon filling funnels along with balloons and accessories. The instructions tell the user to hold the funnel tightly against the faucet or hose bib. This is because most funnels are not threaded to engage the spigot. This is very difficult to do even with two hands and there is an obvious loss of water pressure and the often times funnel falloff resulting in failure. These products are designed for single use applications and are practically worthless.
Water balloon nozzles do not have a means for tying the balloons. Both Water Wars and Water Balloon Battle have integrated tying stations on their larger filling stations. Both Unique Industries and Zoosher have patent-pending designs on foam clips to attach to water balloons separately. These are a little bulky, but relatively easy for tying. The main problem comes from cleanup and reuse, if desired, and the added cost. There is also no effective means of storing after use, or having a tool or device to aid in use, for tying, or to organize prior to use.
Pitchburst is a water balloon dunking station that is targeted to the professional market, and priced higher, accordingly. In its Premium Splursh Kits, it only includes a single nozzle hose adapter with a valve, even though it suggests using the included 11″ balloons which take quite awhile to fill. This is not a very productive system. Similar to other professional systems, it also includes many marketing materials and ornamental structural designs, and even design your own ornamentation, but does not use them for the nozzle or filling component of its system.
Water balloon filling nozzles in the United States are designed to thread onto faucets, hoses, or spigots, but are not made in other sizes. The same is true outside of the United States, with British standard and other sizes. Many on the market or patented sprinkler toys, water toys, tubing, or even my patent-pending applications can be used with different sized nozzles or conduits. This smaller size, and thus reduced material requirement, can have a positive impact on cost to manufacture. And, of course, the nozzle can be made larger as well for connection to other sources or for use with a manifold system, etc. Threading devices also have the limitation of space constraints. When rotating a thread-on device, space becomes a factor when considering any non-standard shape with variable dimensions which may prevent use in some locations.
Most of the ornamental designs for water accessories are for sprinklers or irrigating devices, or lawn ornaments, either for toys or for the home and garden market. Smaller accessories such as nozzles have not undergone the same level of innovation. If most outdoor water toys incorporate ornamental or aesthetic or play components, then the same should be true for water balloon nozzles. Some toy sprinkler devices on the market have fixed or moving parts and/or have tubing or foam ends that are small enough to fit a water balloon and could be marketed with that use in mind, and even in a kit form with balloons and/or nozzle and/or accessories.
Mass market retail packaging is somewhat limited to a single nozzle or also with a kit version and some have two nozzles. This enables the manufacturers to charge more than is necessary and prohibits buying in bulk by the consumer for large events. Also, nozzles are not sold with other things such as books or electronic media. The retail displays do not incorporate other media such as sound or video or computer technology.
Water balloon nozzles on the market do not have a means to protect the dispensing orifice which can become clogged with dirt, for example. Some gardening nozzles have this feature, since those products get repeated use. Repeated use advance the need for water balloon nozzle covers in some applications, and this may be an integrated or non-integrated means, with the nozzle as a part of a larger system.
Sealing water balloons is a difficult task even for skilled users. The prior art included expensive and awkward clips and also a balloon water activated adhesive. The latter product creates an extra manufacturing step and adds to the cost of the balloon. Most users would want to use whatever balloons were available with a particular nozzle and there is the possibility of intermixing of balloons from several manufacturers resulting in not knowing which balloons had the adhesive quality. It is shown here that adhesive balloons or water balloons be specially designed or marked for quick identification, and that is part of the intent of this invention and its various kit forms.
Connecting to indoor water faucets is a challenge since the threaded portion is often covered up with a screened adaptor that is hard to remove.
Application 20056176339 describes a water balloon with integrated adhesive features. The main problems with this are the potential toxicity of adhesives or sealing feature if these balloons are put in the mouth or any other mucous membrane or the eyes or onto an animal, or even if activated by moisture in the environment causing a cleanup issue. There is also an additional cost to manufacture these balloons and great care has to be taken during shipment as well as preparation and use. Water balloons are around water and many may become activate.
Most air and helium nozzles, accessories, pumps, and tanks are designed for functional utility and do not incorporate ornamental features. For example, U.S. Pat. No. 6,932,125. www.balloontime.com would be even more kid and party friendly with an ornamental tank and/or nozzle design, as a way to improve that design.
U.S. Pat. No. 6,149,488 and U.S. Pat. No. D417471 by Ja-Ru is a water bomb dart, and a great idea. Yet, its portable filler is difficult to use and has a very small volume. The dart also requires a tied balloon to be inserted into the flying slot. Having a better filling nozzle and a better tying means would dramatically improve the use of that invention and perhaps encourage bulk sales and new designs.
Hose Clothes are products designed to functionally and ornamentally cover a garden hose, but no focus on accessories or hose bibs, or faucets, etc. Nothing has been innovated with covers. The same or similar systems can be used for water balloon nozzles and accessories. Hose Clothes can also be a component of this system, and our other related applications, too.
Water guns, pistols, soakers, and cannons are sometimes difficult to refill and water balls or other toys are also challenging to fill or soak at times. A more flexible and/or accessible system would aid in various play activities.
Linky Sprinks and other similar toys are solely patented for the teaching or educational aspects and limit the possible scope of the invention. Water balloon filling nozzles or stations or even other hoses or ornamental hoses or any water based object could be added to encourage children to learn about gardening or farming or livestock or animal or plant care or car washing or irrigation, etc. Linky Sprinks can be a component of this invention and our other pending applications.
Fire Hose Hero is a toy backpack with a hose and dual function nozzle. It is different from the gear used by professionals such as is sold on Edarley.com. There exists a need for toy nozzles and gear made with more of a professional image that could be used by professionals for children educational and training purposes. There also exists a need for a water balloon nozzle adaptor for devices like Fire Hose Hero since the technology is remarkably similar to the No-Knot Balloon Device and other patented products. The consumer gardening market now sells hose nozzles with more sturdy push mechanisms similar to some professional fire hoses. A simple toy nozzle with these features would be beneficial and could include a balloon filler, or not.
The prior art does not address a means to hold water balloons on the nozzle or filling device. This can be a problem for some users due to improper initial placement of the balloon on the nozzle or the chance for falloff due to weight of the balloon with the water or fatigue or any number of reasons.
The prior art does not have an ergonomic or user-friendly means for nozzle attachment to a water or object source. Many consumer gardening accessories have attachment points that snap or rotate or turn or swivel without impacting the main part of the unit. Some of the prior art water balloon nozzles do not even have exterior grooves or angles with which to grab and twist onto the source, but are completely round and can be quite slippery when trying to thread. Some of these nozzles even break during use due to the thin-walled construction or the interior grooves not matching up properly with the source threading. Sometimes tools such as wrenches or pliers are required to turn nozzles onto the source which can damage the nozzle. Even with all of these efforts, sometimes the nozzle leaks water or is broken in the process. Nozzles with tool-ready grooves or angles perform much better and are usually constructed sturdier. Most of those nozzles come with a washer which also helps prevents water leakage.
Most water balloons and nozzles are sold by balloon, water toy, or party supply manufacturers or distributors. Most of those companies have focused product development efforts and licensing efforts toward other core lines. Most of these companies target one or more of: individual professionals, balloon stores, distributors, event planners, party stores, or various mass market retailers. That has left a sizable market open for others.
Further evidence to support the industry's consideration of nozzles as a relatively unimportant product in the product line is the fact that most companies do not place either a product name or number, product line name, brand name, company name, logo, patent(s) pending, or patent number(s) or even a sticker or other identifying means on the nozzle itself. Some manufacturers use an outside source for washers and some of these are marked. Some manufacturers place a number or letter or symbol near the intake orifice inside for informational purposes, but this serves no purpose for the consumer. Ja-Ru places its name and country of manufacture on a generic nozzle on the outside surface. Imperial places its name, logo, copyright date, and country of manufacture on the bottom of the nozzle in extremely small raised print. This location almost guarantees that consumers do not even see this vital marketing information. In general, with most manufacturers, some or all identifying features are left for packaging and other marketing methods which do not focus as much on nozzles as on selling balloons. More innovative nozzles should increase balloon sales.
The growth and need and/or desire among consumers, manufacturers, and governments for recycling is increasing. The numbers placed inside some prior art nozzles are resin identification codes or SPI codes. Most consumers do not know what those numbers mean unless a recycling symbol is placed around the number. No nozzle manufacturer, at present, includes a recycling symbol with the number. In fact, many numbers are very difficult to read due to manufacturing mold issues and convey little information to the consumer if any due to the hidden location. Armed with a better understanding of the codes either on packaging, other marketing means, or on the product itself, consumers could choose nozzles made with stronger materials or features and be more environmentally conscious in their initial buying and end-use discarding decision processes. Furthermore, the balloon industry could take another vital step in improving its image as an industry which creates products resulting in waste either in landfills or throughout the environment. Many states now ban or are considering banning balloon releases for environmental reasons relating to product impacts on animal life and various other impacts.
Even more evidence for sales methods focused on balloons is the fact that the patented Pioneer “Funsational” nozzle is not sold separately, but bundled as a kit with balloons or a slingshot or ammo bag, etc. Most other manufacturers follow similar practices. The very few water balloon nozzles that are sold separately from balloons are the generic kind without any stop mechanisms and are vastly overpriced for a simple piece of molded plastic. Consumers can buy more advanced gardening accessories with shutoff couplings and a rotating source connector and a washer for the same or less cost. Plus, those gardening accessories are made out of higher impact materials for long-term use.
Qualatex has the patent on Geoshape balloons and manufacturing mandrels and molds (U.S. Pat. No. 4,943,225), but did not patent geoshape nozzles or accessories nor did any other manufacturer. New ornamental and functional embodiments for nozzles in invention will require new molds to be made and this invention is intended to cover all new water balloon nozzle designs and the molds and software that make them.
Water balloon nozzles are generally mass produced in molds in batches with multiple nozzles. These molds are then separated. Quality standards and inspections are not given the same priority as with more expensive products since the nozzles are deemed disposable. Sometimes, however, burrs remain where nozzles were separated from the mold or another nozzle. Sometimes these burrs are of sufficient size to break a balloon (water balloons are made to burst) or be noticed by a finger rubbing on it. Sometimes there are burrs in the threading which impede attachment to the source or the material is not strong enough to thread onto the source without becoming destabilized.
Water balloon nozzles have varying ingress and egress sizes and features. Some have one small ingress, some have multiple small ingresses or clustered ingresses ('199), and others without stop mechanisms use larger ingresses. Non-stop featured nozzles tend to have smaller egresses than nozzles with a stop feature. Fluid mechanics suggest optimal ranges of ingress to egress, but quick filling with nozzles having a stop feature works the best. In reality, it is the pressure of the filler source that has more impact on the filling process. The longer the balloon is stressed by attachment to the nozzle, the more stress is placed upon it. Latex balloons like many flexible substances tend to perform better when stretched prior to use since the rigidity of product memory needs to be overcome. Care should be taken to not over-stretch the balloon which could cause damage.
Water balloon rockets (U.S. Pat. No. 5,538,456) and water rockets have some unique filling requirements due to product length or difficulty of design or handling due to weight or dimensions. A water rocket may benefit from an accessory or extension or stand to stabilize it or some other means.
Water balloon grenades (U.S. Pat. Nos. 5,356,327, 5,531,626, D301595, D750025, and others) as well as tye-dye colored and cherry-scented water balloons are the main innovations from standard one-color or one-function water balloons. Similar innovations and many, many more are available in air and helium-filled balloons, but filling devices have not evolved to that level until this invention.
Water grenade fillers are portable plastic fillers in the shape and color of a water grenade that often does not have enough capacity to fill one balloon and is very difficult to use. It also has the danger of being tossed by young children and could cause injury since it is made of a hard plastic. Additionally, one end cap is small enough to be swallowed by a young child or animal causing injury as well.
Axiom International distributes a few innovative water bomb kits. Some have a nozzle and portable filler and some have two portable fillers, but these kits are designed for single use or disposable applications, as are its sling shot kits.
Water balloon nozzles are made to slip onto a small orifice or at most a standard hose bib or plumbing faucet. This design is not conducive to adapt water balloons to balloon stuffing technology. Balloon stuffers use an external force which is usually mechanical or electrical to force an object into a balloon. Most water balloons nozzles are fortunate to have access to a pressurized source of potential energy, thus, negating the need for the more expensive means often used for air or helium balloon stuffing. A larger orifice would be more beneficial primarily, but also the potential exists to have a water balloon nozzle with a rim stretching feature and/or an object selection or inserting means or device either as part of the nozzle or as an additional accessory. This invention covers all embodiments of balloon stuffing water balloon nozzle systems.

### Preferred Embodiments

### Nozzle

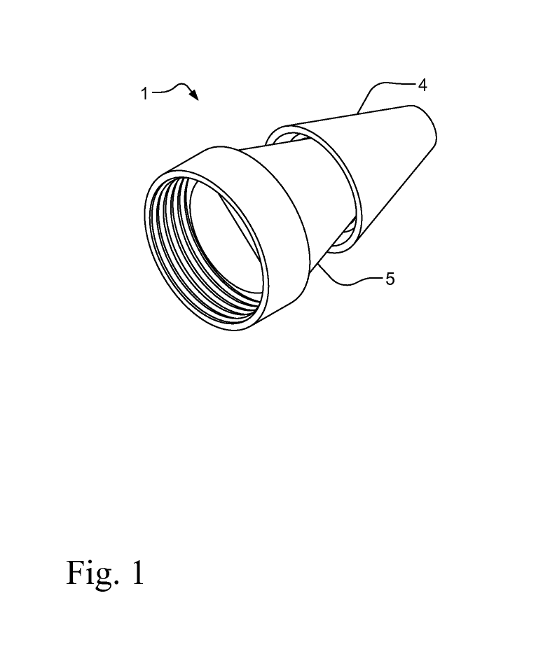

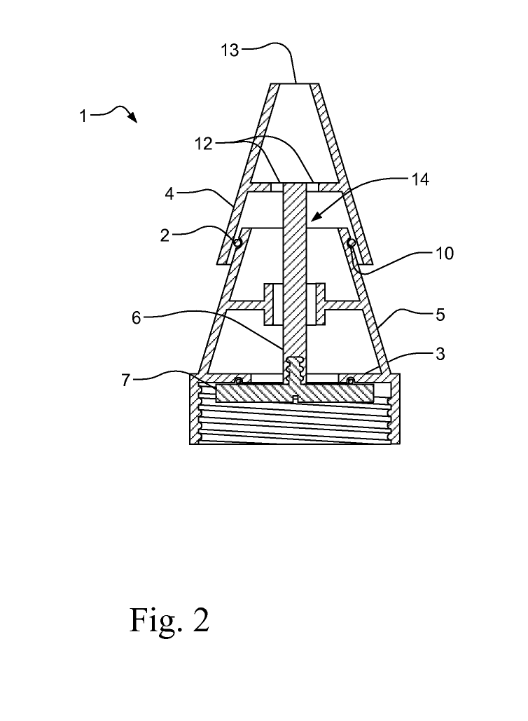

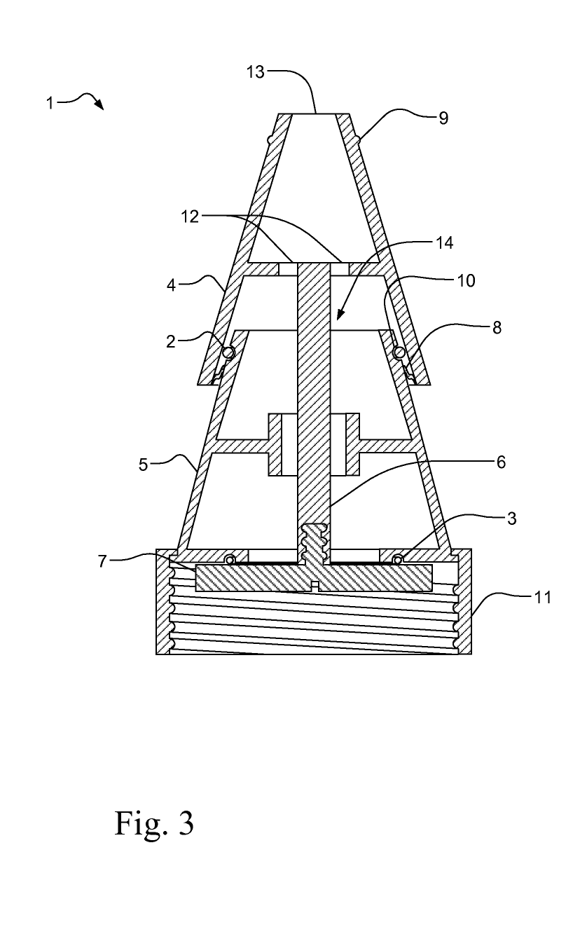

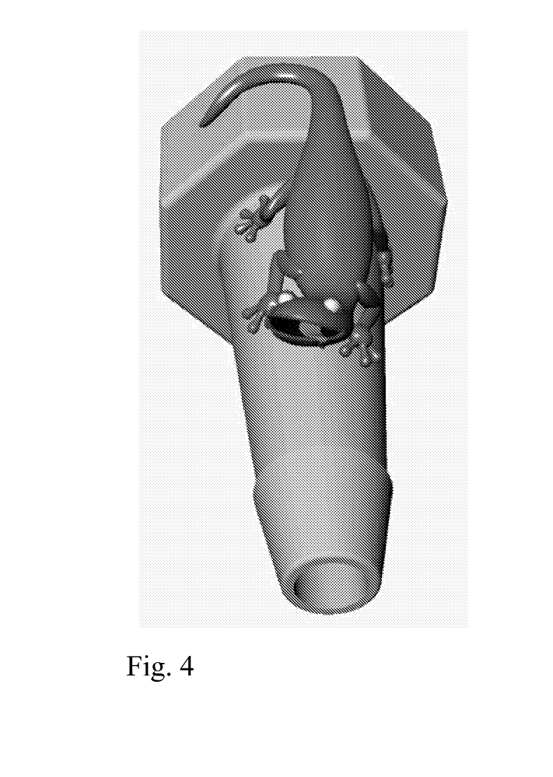

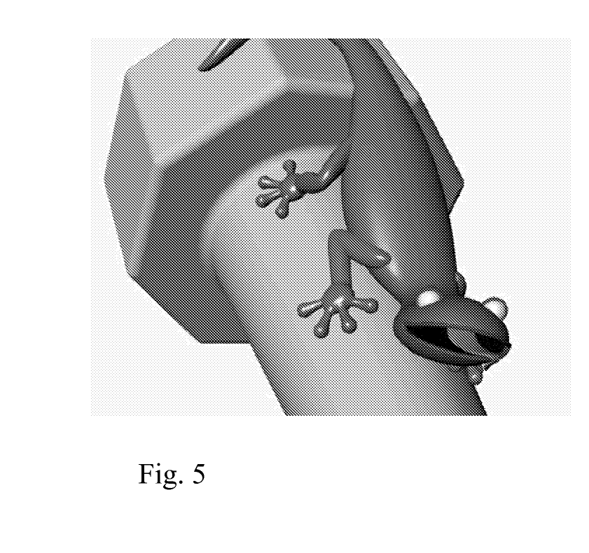

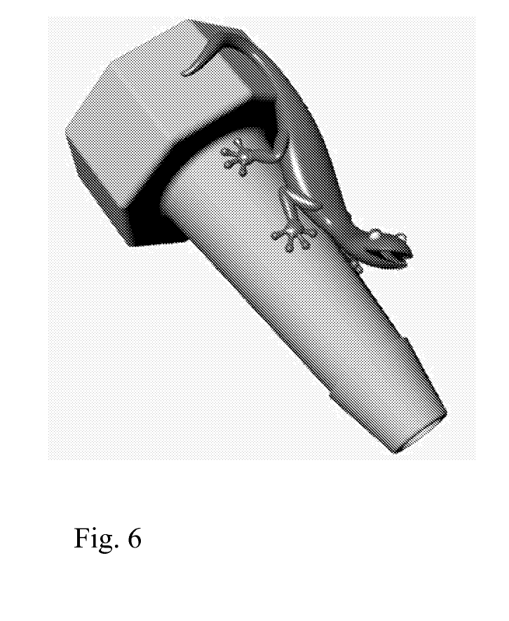

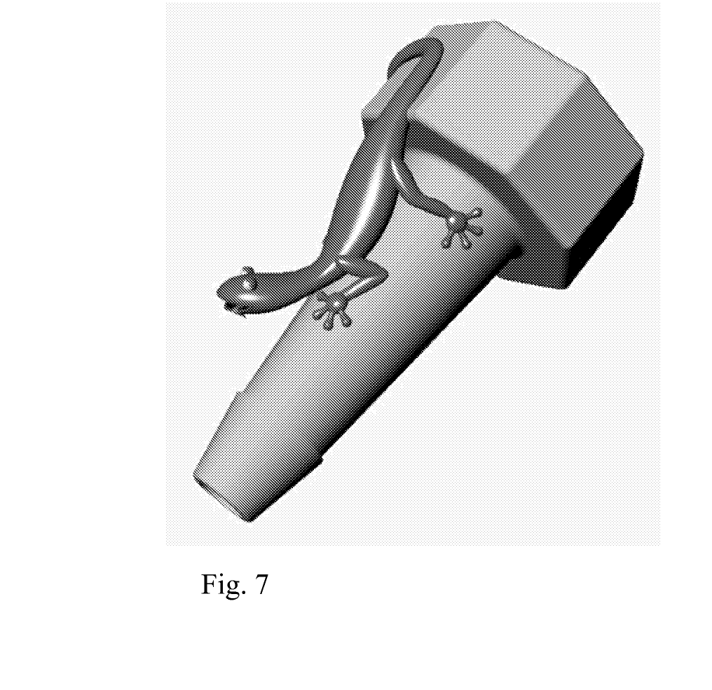

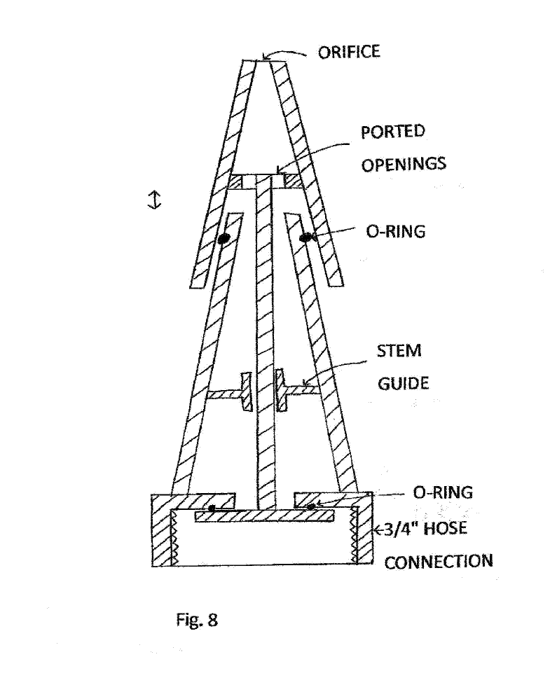

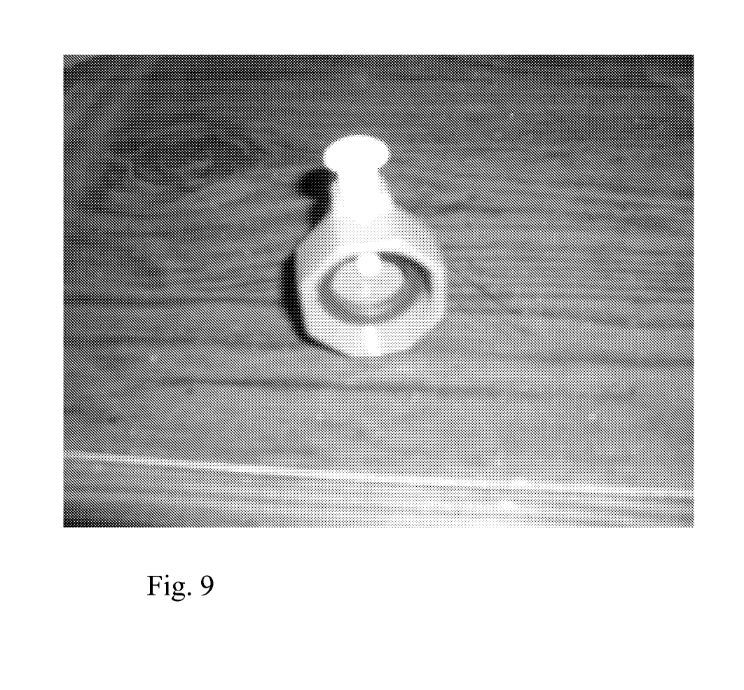

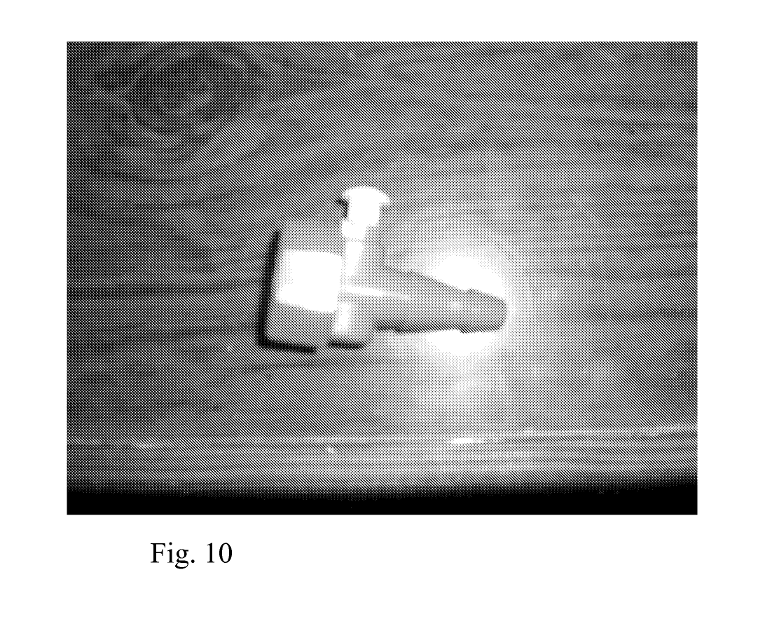

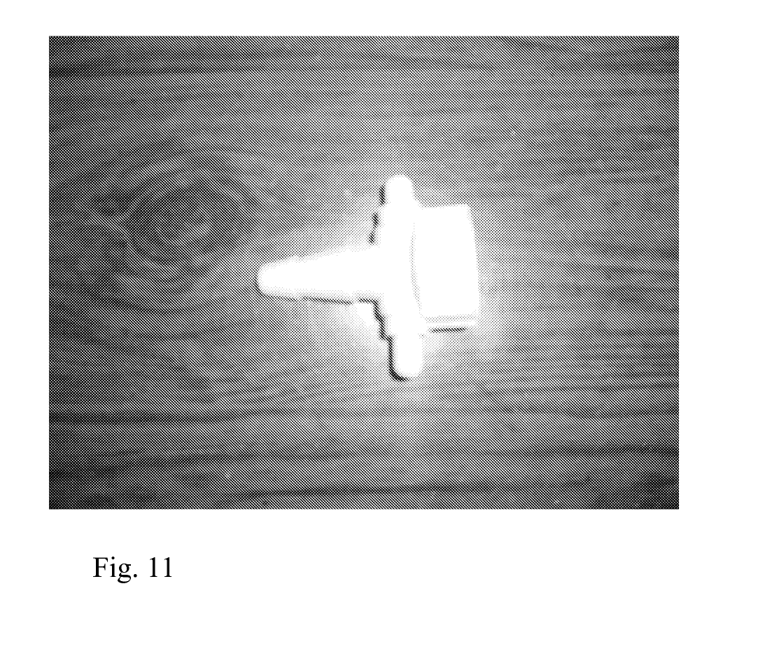

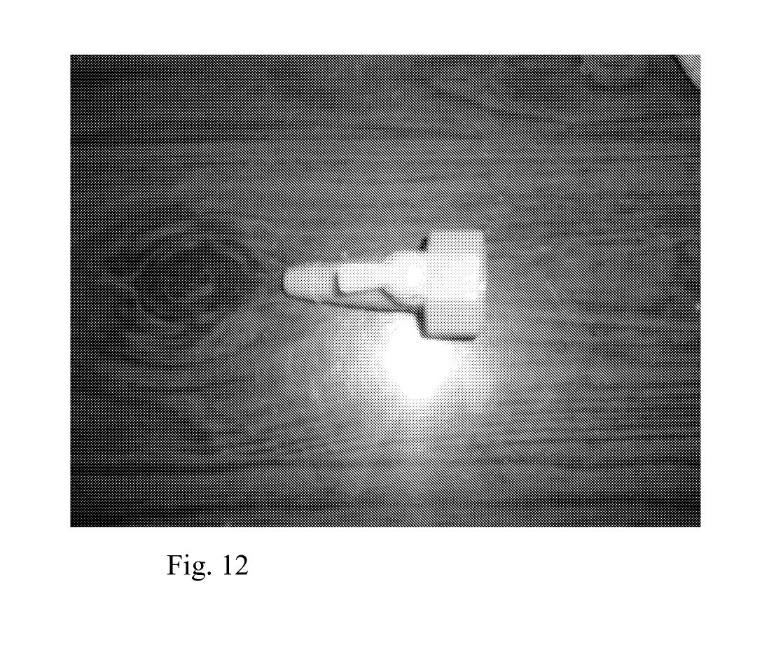

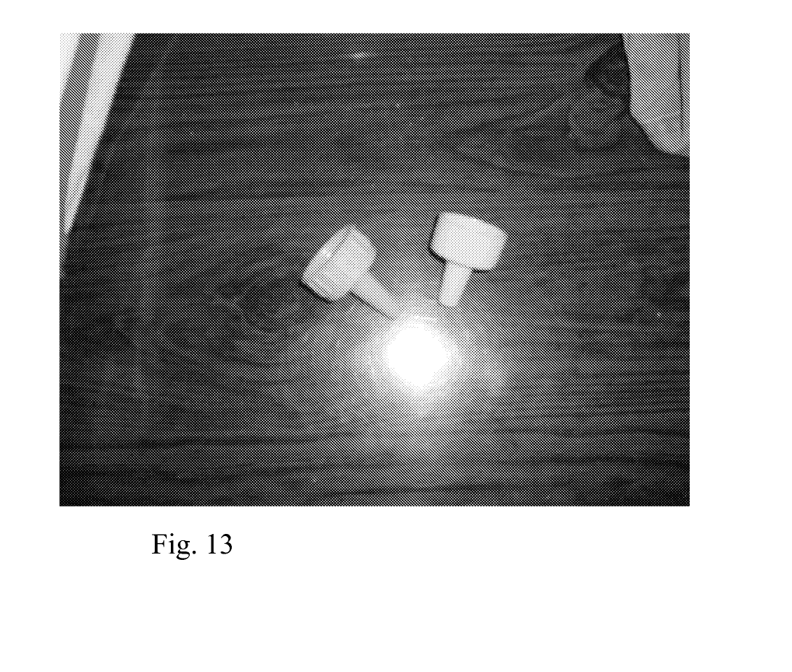

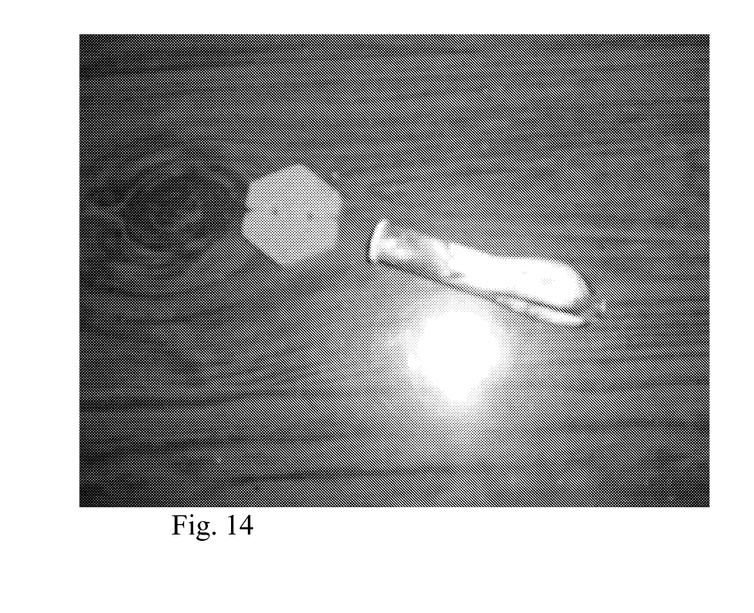

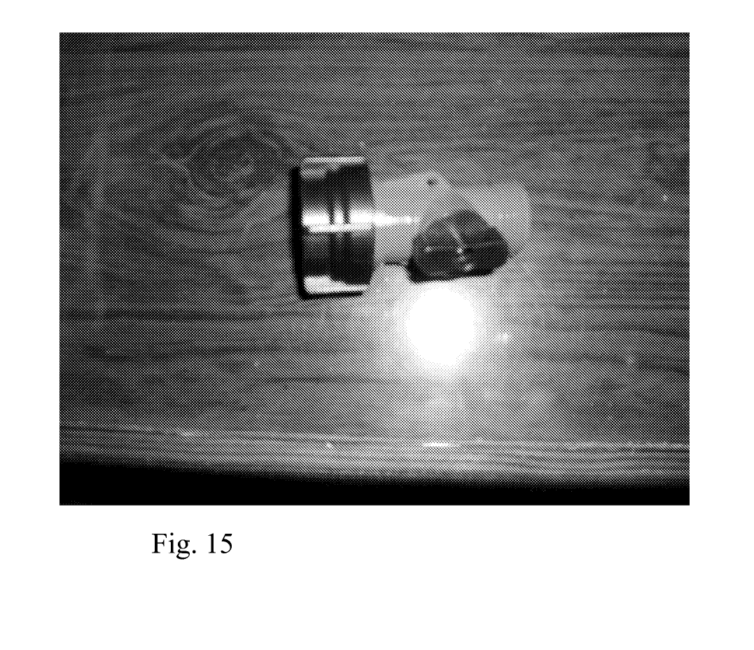

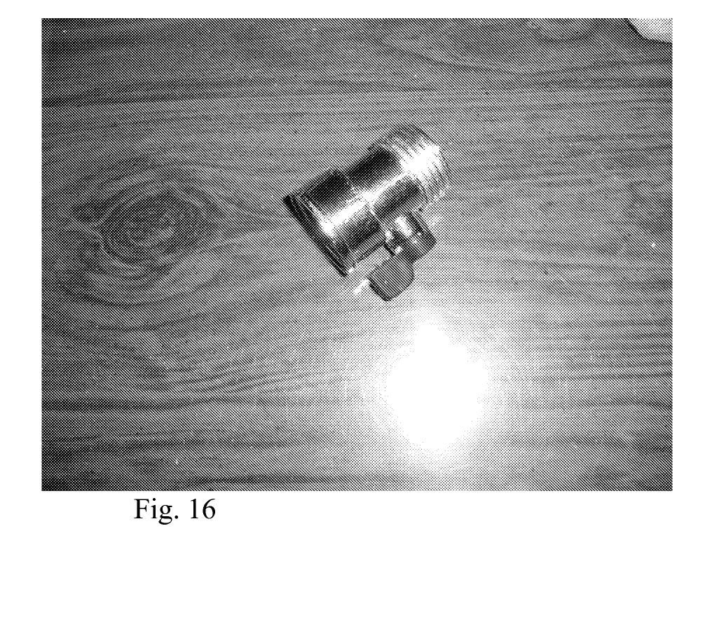

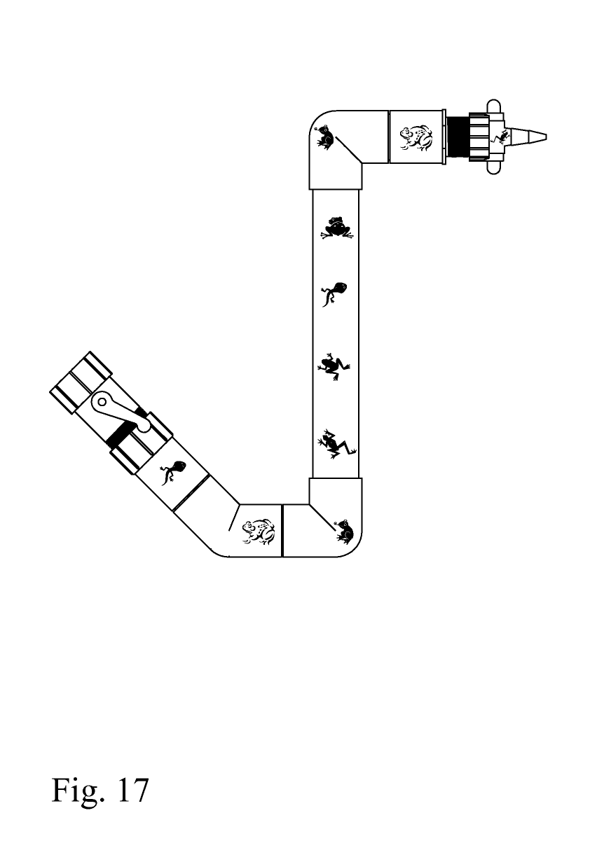

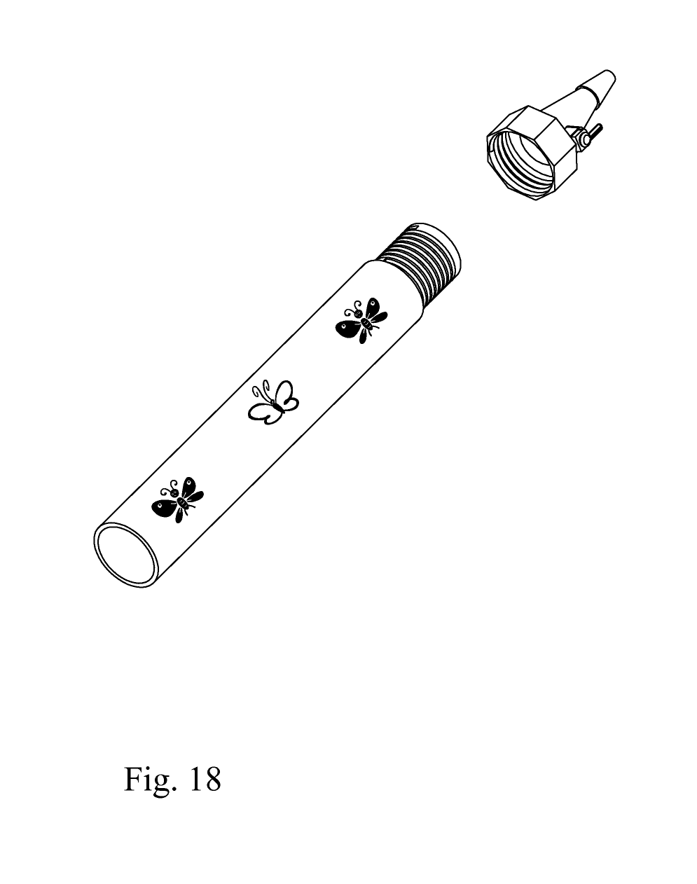

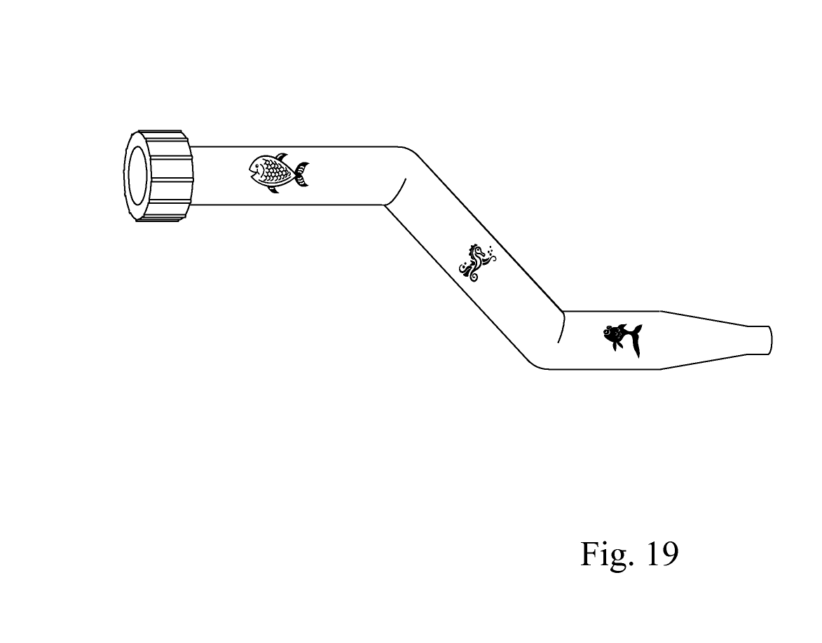

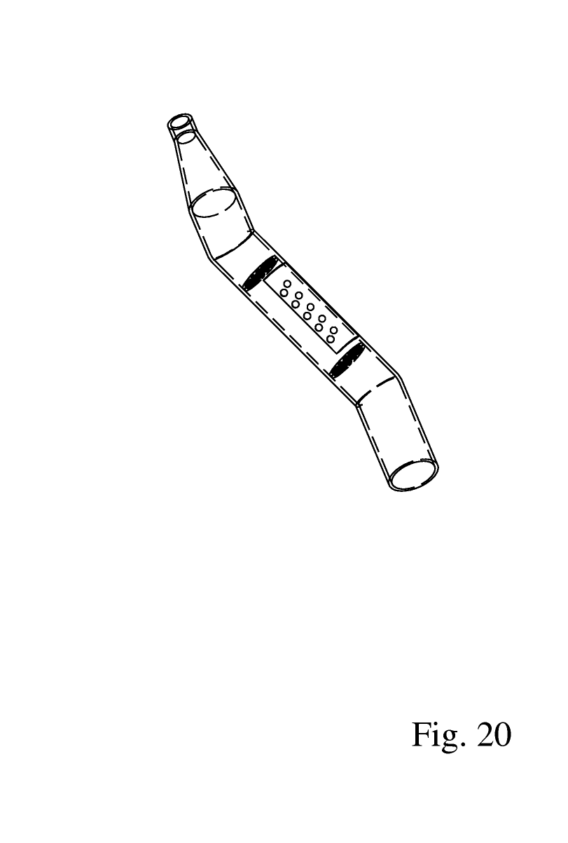

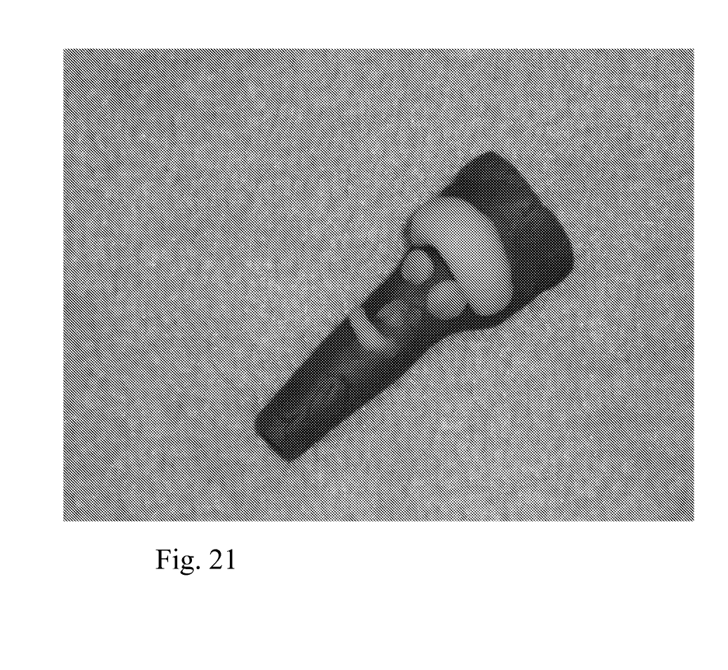

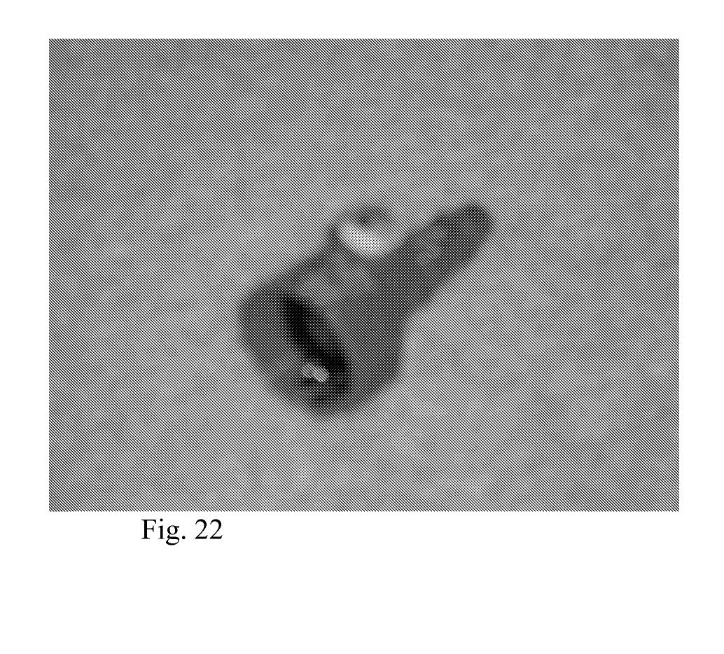

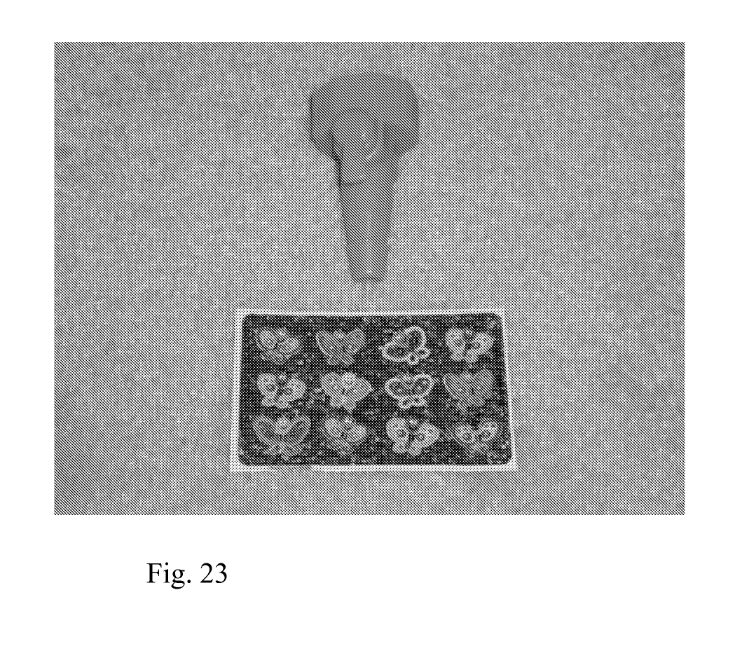

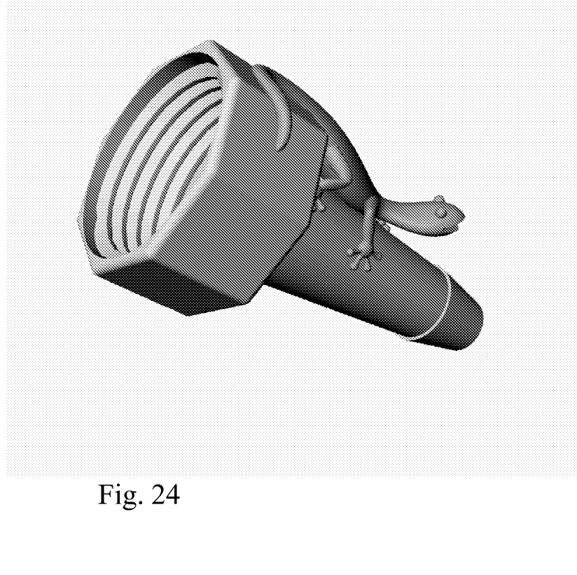

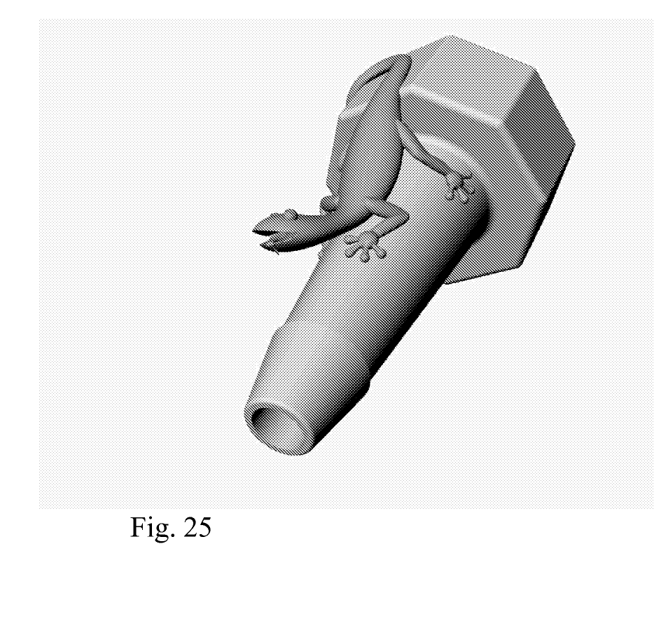

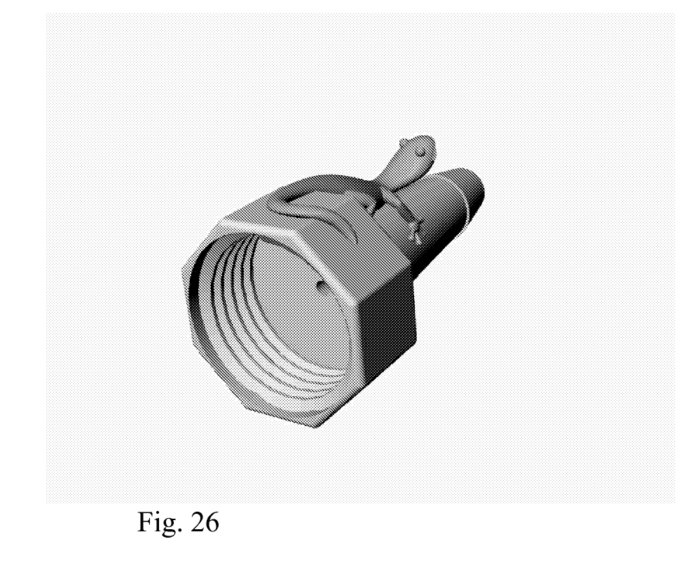

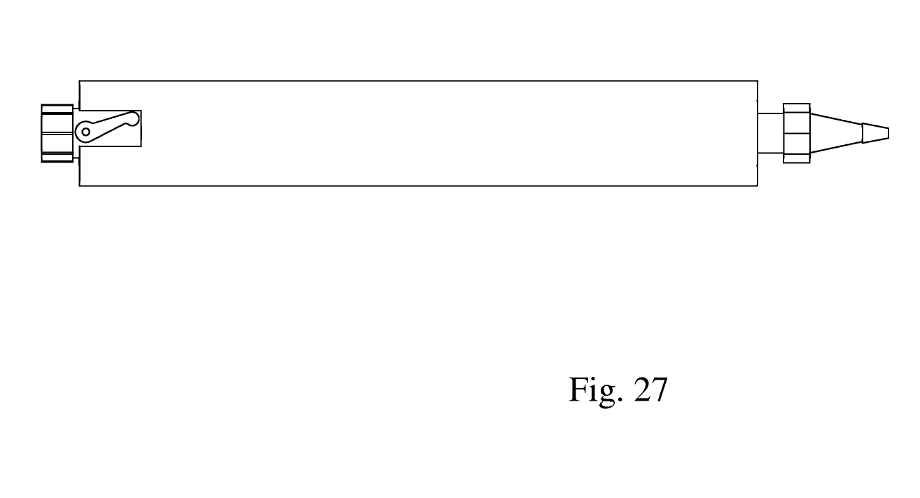

For this section, please refer to FIGS. 1-3, 8, 28-35. One embodiment is a water balloon valve that can be actuated by the force of placing the water balloon on the nozzle or similarly by one hand to fill a water balloon while still holding the balloon with that same hand. There are various means of accomplishing this design and are included in the scope of this invention. The most user friendly option is a push mechanism by which the balloon is slid onto the nozzle and then further user force engages the water release. To disengage, the balloon is pulled back or off and/or the force is reduced or stopped. One means is via a multi-conical system. It may consist of a front cone and a back cone. The back cone fastens to a hose connection. The front cone is connected to a shaft and plunger. When the front cone is pressed or pushed, it opens the plunger allowing flow through the valve. The front cone seals against the lower cone, minimizing any water that escapes. The balloon would frictionally slide onto the front cone, which could be grooved or designed to secure the balloon. The plunger seals against a back piece using an O-ring. The ingress opening can be made larger or smaller to allow more or less flow as desired. The front cone is fixed to the shaft, but flow can pass through the attachment via a ported opening or openings. The front cone also may have an interior lip that seals against the top rim of the back cone. The front cone may be fixed to the shaft using a molded plastic connector or a one-piece mold, to minimize costs. If the shaft was metal or a strong thermoplastic, the top cone could be secured to the shaft with a fabricated piece threaded onto the shaft. The threaded connection would permit disassembly for replacing the O-ring, if necessary. The threaded connection may also include a device to make connecting easier to the filler source such as a swivel nut which is a preferred design. A preferred design may have the conical sections move along a substantially horizontal or vertical plane instead of a substantially diagonal plane which may improve functionality, especially of the seal.

Number 1 represents the nozzle of our invention, in general. There may be one or more nozzle 1 or a variation(s) of one or more nozzle 1. There may be no nozzle 1. Nozzle 1 may or may not have ornamentation, all or in-part. Nozzle 1 or any part or parts may or may not comprise one or more colors and/or materials. Nozzle 1 or any part or parts may or may not comprise a means for other objects or devices or ornamentation to attach or detach, either temporarily or permanently, all or in part.

Number 2 is a seal device. There may be one or more or no seal device 2. Seal device 2 seals parts 4 and 5 as the filling function is engaged and disengaged. Seal device 2 may be fixed, permanent, adjustable, or removable. Seal device 2 may or may not have ornamentation all or in part.

Number 3 is a seal device. There may be one or more or no seal device 3. Seal device 2 and seal device 3 may be the same, similar, or different seal devices. Seal device 3 seals parts 5 and 7 as the filling function is engaged and disengaged. Seal device 3 may be fixed, permanent, adjustable, or removable. Seal device 3 may or may not have ornamentation all or in part.

Number 4 is the egress section. There may be one or more or no egress section 4. Egress section 4 may or may not have an actuation mechanism or have multiple actuation mechanisms. Egress section 4 may or may not be attached to ingress section 5. Egress section 4 may have one or more or no ingress or egress. Egress section 4 may or may not seal against ingress section 5. Egress section 4 may or may not have a ported opening or openings to allow an object or objects to pass through from ingress section 5. Egress section 4 may or may not comprise a means of guiding a stem or stems or other objects.

Number 5 is the ingress section. There may be one or more or no ingress section 5. Ingress section 5 may or may not have an actuation mechanism or have multiple actuation mechanisms. Ingress section 5 may attach to the input source by any means or no means. Ingress section 5 may use an intermediary device(s) or accessory(s) to attach to the input source by any means or no means. Ingress section 5 may have one or more or no ingress or egress. Ingress section 5 may or may not comprise a means of guiding a stem or stems or other objects.

Egress section 4 and ingress section 5 may be the same part or there may be multiples of each or none of each or any combination. One or more or no egress section 4 and ingress section may be conical, circular, triangular, rectangular, polyhedral or partially or substantially one of more of these or other shapes or none of these shapes or any shape or change shapes all or in part. Egress section 4 and ingress section 5 may or may not move or rotate or twist or slide or other means in the same manner or method along one or more or no plane or surface either on the interior or exterior or both all or in part. Egress section 4 and/or ingress section 5 may or may not have ornamentation all or in part. Egress section 4 and ingress section 5 may or may not be comprised of the same material or materials all or in part. Egress section 4 and ingress section 5 may or may not have one or more screens or filters or see-through components all or in part. Egress section 4 and ingress section 5 may or may not be designed to touch or connect in either the open or closed valve position or somewhere in between. There may be other sections, parts, or devices designed to actuate the system.

Number 6 is the stem. There may be one or more or no stem 6. Stem 6 may or may not attach to egress section 4 or ingress section 5 or to any other part or parts. Stem 6 may or may not have a stem guide that may or may not be attached to ingress section 5 or to another part. Stem 6 may or may not have ornamentation all or in part. Stem 6 may or may not be threaded, slotted, angled, notched, or have a means of attaching and detaching from stem stop 7.

Number 7 is the stem stop. There may be one or more or no stem stop 7. Stem stop 7 may or may not attach to stem 6, or egress section 4, or ingress section 5 or to any other part or parts. Stem stop 7 may or may not function without seal device 2 and/or seal device 3. Stem stop 7 may or may not have ornamentation all or in part. Stem stop 7 may or may not be threaded, non-threaded, quick connect, swivel nut or swivel device, snap in/out device, slotted, angled, coned, notched, or have any means of attaching and detaching from stem stop 7. Stem 6 and stem stop 7 may be the same part or be configured in various ways. Stem 6 and/or stem stop 7 may or may not comprise a screen or filter or other device.

Number 8 is the membrane. There may be one or more or no or partial membrane 8. Membrane 8 may serve as a primary or secondary or tertiary or other seal means. Membrane 8 may or may not seal all or part of nozzle 1. Membrane 8 may be flexible or rigid or a combination. Membrane 8 may or may not seal and/or attach to egress section 4 or ingress section 5 or to seal device 2 or to any other part or parts. Membrane 8 may or may not have ornamentation all or in part. Membrane 8 may or may not serve as an additional ingress or egress or conduit to or for another feature or device. Membrane 8 may be attachable, detachable, removable, or adjustable all or in part. Membrane 8 may or may not be on the exterior, interior, or both or separate from egress section 4 and/or egress section 5 all or in part. Membrane 8 may or may not have a screen or filter or see through component.

Number 9 is the fill surface. There may be one or more or no or partial fill surface 9. Fill surface 9 may be integrated or not into egress section 4 or ingress section 5 or to another part or parts. Fill surface 9 may be removable or adjustable. Fill surface 9 may serve one or more other functions. Fill surface 9 may or may not be on the exterior, interior, or both or separate or partially separate from egress section 4 or any other part of parts. Fill surface 9 may be ridged or indented or recessed or partially one or more of each of those or another means. Fill surface 9 may or may not have ornamentation all or in part. Fill surface 9 may or may not be sized to fit one or more types of balloons or toys or other objects.

Number 10 is the seal ridge. There may be one or more or no seal ridge 10. Seal ridge 10 may be on, in, recessed, beside or part of egress section 4 or ingress section 5 or seal device 2 or seal device 3 or membrane 8 or any other part or parts. Seal ridge 10 may or may not have ornamentation all or in part. Seal ridge 10 may or may not serve to secure, seat, hold, or assist seal device 2 and/or seal device 3 or egress section 4 or ingress section 5 in one or more functions. Seal ridge may comprise any shape or shapes or no shape. Seal ridge 10 may comprise a series of items.

Number 11 is the connecting means. There may be one or more or no connecting means 11. Connecting means 11 may be threaded, non-threaded, slotted, angled, notched, a quick connect feature, a swivel nut or swivel device, snap in/out device or have any means of attaching and detaching to an ingress source or connecting to another part or ingress or egress source or other means of comprising a larger system. Connecting means 11 may or may not have ornamentation all or in part. Connecting means 11 may or may not connect to or engage with seal device 2, seal device 3, ingress section 5, egress section 4, stem 6, stem stop 7, membrane 8, or any other part or parts. Connecting means 11 may be removable or adjustable all or in part.

Number 12 is the ported opening. There may be one or more or no ported opening 12. Seal device 2, seal device 3, egress section 4, ingress section 5, stem 6, stem stop 7, membrane 8, fill surface 9, seal ridge 10, and/or connecting means 11 may or may not have one or more or no ported opening 12. Ported opening 12 may or may not have ornamentation all or in part. Ported opening 12 may or may not be open, closed, comprise a screen or filter or other object limiting device, or comprise a selective or dispensing means all or in part. There may or may not be one or more ported opening 12 at or near or adjacent to any part or parts. Ported openings may comprise any shape. Ported openings may become clogged or blocked and/or require maintenance.

Number 13 is the egress. There may be one or more or no egress 13. Egress 13 may comprise a cover or covers or security or locking means. Egress 13 may be removable or adjustable all or in part. Egress 13 may connect to any other part or parts. Egress 13 may comprise one or more screen or filter or fill surface 9. Egress 13 may be ridged or indented or recessed or partially one or more of each of those or another means. Egress 13 may or may not have ornamentation all or in part. Egress 13 may or may not be sized to fit one or more types of balloons or toys or other objects.

Number 14 is open area. There may be one or more or no open area 14. Open area 14 may comprise or connect to any part at any time during the system process all or in part. Open area 14 may or may not be divided into multiple areas by actuation of egress section 4 and/or ingress section 5 and/or stem 6 and/or stem stop 7 and/or seal device 2 or seal device 3 or membrane 8 or seal ridge 10. One or more or no open area 14 may be partially or fully or overflow or clogged or blocked with accessories or objects inserted into the system. Open area 14 may be adjustable, have insertion points and areas, be cleanable and maintainable, or sized to fit one or more types of objects and/or other functions. Open area 14 may have one or more screens or filters or see-through components. Open area 14 may or may not have ornamentation all or in part. Open area 14 may or may not directly connect with egress 13. Egress 13 and/or ported opening 12 may be partially or fully an open area 14. Numbers 1 through 14 may comprise one or more or no shape, color, feature, or function. There may be other part or parts.

Another preferred embodiment of a one-handed water balloon filling nozzle is a twist type design. Instead of pushing the front cone, it could be twisted or pushed and twisted. This action would cause the front cone to advance along the back cylinder to open and close the plunger. A push type device may be easier to use, but a twist type design may be easier to prevent leakage at the front conical-O-ring-back conical meeting junction. The twist to operate design may require an intermediate cylindrical section which may add slightly to the cost. The O-rings are most effective at the open and closed positions of the nozzle, but may not be as effective at any intermediate positions. Many water balloon nozzles and consumer hose systems have slight leaking issues and are rarely the cause of frustration. However, multiple O-rings or flexible rings or multiple conical sections or multiple internal chambers or a flexible cover or membrane connecting the external conical sections or another means may enhance leak prevention efforts. It is the intention of this invention to provide a nozzle which is easier to use. Additional features and components may be added to the nozzle or system as described in further embodiments.

### Preferred Embodiments

As shown in figures, (for example, Geckos) they are a preferred design of ornamental and/or ornamentally functional nozzles, used to describe the utility added to nozzles by this invention. The ornamentation may or may not be manufactured and molded together with the nozzle or in a multi-step molding process or a separate process or another type of process. The ornamentation may or may not be separable from the nozzle or be attachable or detachable or adjustable or comprise one or more parts with various features. The ornamentation may or may not comprise one or more colors or materials. The ornamentation may or may not be on any interior or exterior surface or both all or in part. The nozzle may or may not comprise the ornamentation all or in part. The nozzle may or may not comprise one or more valves, ingresses, egresses, or seals all or in part.

Ornamentation may or may not comprise or serve all or one or more or none of the following functions all or in part: nozzle, balloon rim or toy ridge, balloon rim or toy stop, gripping surface or grip, handle, clip, hinge, ergonomic surface, balloon or toy holding device, seal device, seal holding device, balloon or toy bursting or breaking device, accessory, valve or stop device, ingress, egress, seal, membrane, swivel or other type of ingress connecting means or ridge for hand or tool, texture, toy, extension device, dispenser, disperser or storage for Hi-float, curling ribbon or other seal type dispenser or storage or cutter, groove or area for object attachment, moving part, rotating part, pulsating part, floating part, twisting part, disappearing or dissolving or changing or transforming part, glowing or shining part, mechanical device, electronic device, biological device, chemical device, battery, solar cell, machine, time display or timer or alarm, nanotechnology, cleanser or disinfectant, soda fountain or other dispenser with or without mixing feature, adhesive or sticky feature, security, lock, cover, see-through component, transparent or translucent or opaque component, reflective properties, absorption properties, storage, light, sound, scent or scent dispersal, heating, cooling, freeze or thaw or overheating protection or prevention, glow in the dark, patterns, internal and/or external flow redirection or restricting or slowing velocity or increasing velocity or adjustment or storage or holding or mixing or stirring or spraying or sprinkling or other means, object or partial object blocking or hiding means (such as obstructing the view of a hose bib), nozzle or valve protection means, ultra-violet light limiting or stabilizer or additive or protection or other environmental source protection means not limited to mold or mildew or fungi or bacteria or animals or plants or insects, distribution or display means, information means, clip or means to attach or store during or after use, color-changing means, using color or other means to show or offset instructions or other letters or numbers or symbols or logos or other things, interchangeable parts, a means to attach or detach other objects or an ingress or egress, screen or filter means, balloon (body or neck or rim) stretcher prior to or after filling, licensed character, theme, collectible, cast a shadow or provide shading, block or redirect or absorb light, collect or redirect dirt or debris or other objects, change the surface plane, comprise or provide a paintable surface or a primed surface, glitter, any decoration-ready component, increase or decrease strength of material or structure, match other toys or lawn and garden or other objects other styles or themes, branding or marketing, recycling symbol or conservation or information means, UL or CE rating, serve as a toy or other device not simply meant or used for filling water balloons, gas and/or mixed gas system or component, and various other functions which are described elsewhere in the application or intended by the scope of the claims.

To illustrate an example much more in depth, a licensed character added to or manufactured on a water balloon nozzle may seem like ornamentation. Yet, no manufacturer has done this before over the course of decades of popular water balloon use. So, it is clearly not obvious. Utility in several areas for this one example is explained below.

Utility for Manufacturers, Distributors, Wholesalers, and Retailers or other Sales Companies

There are many companies engaged in the business of making manufacturing molds as a step in the manufacturing process of plastics injection molding and other types of plastics manufacturing commonly used for water balloon nozzle manufacture. No molds or machines or software to make them, including licensed character molds, exist for ornamental water balloon nozzles. A representative manufacturer or distributor makes or sells other licensed products (some of which are collectibles or well-known items) that may or may not be used at or near the new nozzle with the licensed character and likely sells them in the same store or by other means so this creates a new product line extension. For these example companies and the retail or consumer point-of-sale companies trying to move products off of the shelves in a never ending quest to achieve greater sales per square foot, adding this one sample feature creates utility for it (either in additional margin from higher unit cost/profits or increased volume when compared to the more bland product sitting adjacent to it) and may even help promote its other related or non-related products as well either directly or indirectly.

Utility for the End-User and/or other Associates of the End-User

This example added feature may or may not also serve other user functions. Some ornamentation, such as licensed characters, may be manufactured on the top half or so of a nozzle to ensure it is in plain view of the user when installed. This application asserts that such placement on products may directly add other features such as ultra-violet light protection or material strengthening to those areas as well as others. Many plastics, including thermoplastics, such as those used in water balloon nozzles are made inexpensively and without longer term considerations or without perhaps adding ultraviolet stabilizers to prevent material oxidation and degradation. Adding ornamentation may also add plastic material depth and structure, thereby increasing ultraviolet light resistance without necessarily having to add ultraviolet stabilizers to the plastic resin compound during manufacturing to achieve longer product life.

Moreover, adding this licensed character feature opens up the product to even more non-traditional uses that can be marketed, packaged, and promoted such as for a nozzle for exterior watering or gardening or car washing or attaching the nozzle to an interior faucet for promoting hand or body washing or teeth brushing or any other type of purpose that would encourage the intended user or other users to make use of it more for the water balloon purpose or for other purposes.

In one embodiment, it includes a nozzle extension with an example of ornamentation. The nozzle is designed to bring the height of the egress higher to make it easier for a user to access the nozzle particularly from a hose bib installation. The extension may or may not go lower, higher, inward, outward, beside, or adjacent to or any combination of one or more of those or any other direction from the filler source. The extension may comprise one or more nozzles or no nozzle. The ornamentation may or may not serve one or more functions.

In one embodiment, it includes an ornamental extension nozzle with multiple moving parts, internal screens that retain moving parts in a cavity while allowing fluid passage, and an external see-through component. The ornamentation may or may not serve one or more functions.

In one embodiment, it includes an ornamental nozzle with a swivel nut feature and other attached objects.

Different Types of Water Balloon Nozzles

These types fall into two main categories, nozzles with a valve means and nozzles without a valve means. Some of these nozzles have a few other functional components such as balloon gripping ridge or ridges (these are not ornamental in nature and patent '199 describes the intended function when it mentions frustoconical sections), hand or tool turning ridges, washer, ingress threading, relatively straight conduit, on/off valve indicator, and egress hole.

This patent also covers the kits based on the inventions mentioned above.

Below are some other embodiments, but are not meant to limit other possible embodiments:

Extensions and Extension Kits:
One or more flexible or non-flexible and/or adjustable or non-adjustable positioning device that can be the conduit or be a cover for the conduit. This can be functional or ornamental or both. It can be manual or electric and can be interchangeable or modular. It can be inflatable or can be filled by another means. The nozzle itself can have a cover or covers with similar functions.
One or more extension device in a simple mechanical fixed form or variable form as well as more complex manual or automatic or electronic extensions.
One or more extension device with a kink prevention mechanism and/or a coiling means.
One or more nozzle or extension device using flat hose technology enabling it to be in a flat state until pressurized. A flat hose component or components enable compact storage and freedom of movement and setup in various directions or areas. This feature or features can be in one or more storage dispensing devices.
One or more nozzle or nozzle extension or accessory that enables user access to the side either to the left or the right or the top or bottom or substantially to those areas or anywhere in between or to other areas. This will be helpful for areas where access is difficult.

Valve Types:
One or more push/pull or twist mechanism going in and out, as opposed to up and down or through, such as the ones in other various prior art.
One or more flexible push button as can be found on some laundry detergent bottles.
One or more nozzle or valve or extension designed to adapt to hydration systems or water filtration systems for indoor or outdoor use. It can be integral or an additional accessory. It can attach to the unit or be separate. It can be made of flexible material or a combination of flexible and non-flexible material.
One or more foot pumps designed to allow both hands to be free and still operate the nozzle by foot power.
One or more press down pump handles like for dishwashing liquid bottles.
One or more press below handles like for spray bottles.
One or more pull up/down handles like for dishwashing liquid bottles.
One or more press around nozzle handles (new design incorporating force of fingers around balloon.)
A nozzle with pressure points or activated by pressure points.

Various Ornamentation and Functional Ornamentation:
Any ornamental or aesthetic or play or electronic or functional improvement to prior art.
Multi-color nozzles, exterior view and/or interior view, and not just having a different color body and valve handle, with multiple colors on one or more of the component parts.
One or more scented nozzles or components or scent activated by substance flowing through it or inserted.
The use of materials including color to introduce new features such as adding strength or protection to the structure.
Multi-pattern nozzles such as tye-dye and camouflage and grenade and rocket-shaped to approximate existing prior art balloons and filler as well as new multi-pattern designs.
One or more shapes such as any animal, plant, insect, amphibian, reptile, fish, human or non-human object, etc.
One or more nozzle or components that are modular or come apart or can be put back together all or in part. These components can fill with water or not or hold other nozzles or objects such as toys or other portable fillers for water balloons or water toys or serve as a docking/filling station for water gun type toys.
One or more nozzle that can be added to a sprinkler toy or to another toy such as Linky Sprinks or can be interchangeable with sprinkler toys. An adaptor for tubing would enable the user to hook up to irrigation systems or other toys.
One or more nozzle or components with electronic or voice-activated nozzles or accessories.
One or more nozzle or components with an Underwriters Laboratories or (UL) or CE rating.
One or more nozzle or component with a balloon stuffing or stretching mechanism or as an accessory.
One or more nozzles or components that play or record sound or sounds or music or can be programmed to do so. Or have adjustments for one or more volume, stop, fast forward and rewind, and pause, as well as other features.
One or more nozzles or components that display time or any other numerals, characters, or symbols.
One or more orifice cover or a nozzle cover all or in part.
A nozzle device with a flexible or adjustable (rubber) gasket on the attachment end to go onto a hose bib, water faucet, or nozzle, or hose, etc. that allows the user to easily install and remove the unit. This is particularly helpful for an indoor water faucet where removing the thread on cover is not always the best option when using an off-the-shelf nozzle.
A nozzle where the unit is designed to have all or a majority or some of its mass below, the right, the left, or above the main water source. A preferred nozzle would have most of its mass or egress above the main water source which would allow easier access for the task of filling water balloons.
A nozzle with one or more drilled holes or tapped areas or other means to attach other objects or accessories.
The system may use solids, liquids, or gases or combinations of them.
One or more integrated and/or separate parts that may or may not be a valve or seal means.
One or more components with one or more magnetic properties.
One or more components with one or more plush toy or stuffed toy properties.
One or more components with one or more building block or construction kit features.
One or more components designed for individuals with disabilities and/or with one or more multi-sensory (taste, touch, sight, smell, hear) appeal.
One or more components made from or with one or more ultra-violet light resistant or stabilizing materials.
One or more covers or other devices may serve as an ultra-violet light protection or enhancement device.
One or more components or covers made from anti-mold or anti-mildew or anti-bacterial or anti-fungal or insect-repellent materials.
A unit designed to wet one or more sponge balls or water balls and/or store them or provide a means to use them in an activity or even launch them.
One or more storage means for a nozzle or accessories such as a storage bag or enclosing device, a place on slingshots, catapults, or launchers, or a place on or in an ammo bag or water balloon waist tie bag, etc.
A water balloon launcher, slingshot, or catapult with one or more integrated filling device or a place to store one or more filling device.
One or more belt loop or other means for holding or transporting or securing a nozzle or accessories.
Slip on or tie on or Velcro or zipper or stick on or other means to use Hose Clothes or other ornamental or decorative features or covers for the system.
Devices which snap or stick or attach or otherwise are utilized with existing prior art nozzles and provide extra functionality or ornamental value.
Devices which coil or partly coil or return to the original position or can be secured at a set position.
Nozzle or accessories could be licensed characters or any part or parts could be licensed characters.
One or more fluid or pressure activated functional or non-functional components that could be moving and/or ornamental.
One or more functional or non-functional component that can be fully or partially suspended in a fluid medium at any time.
One or more component designed for disposability or for non-disposability/reuse.
Insert-ready objects or candy or prizes or colored liquids, etc. and/or a feature to enable one or more objects to be inserted simultaneously or in a random or non-random pattern.
One or more reflective, transparent, translucent, opaque, etc. or combinations of one or more of these properties.
One or more glow in the dark feature or body heat activation or infrared feature.
One or more electronic component or components.
One or more touch screens or buttons or components.
One or more lights, bulbs, LED's, batteries, generator, electric cords, computer programmable features, timers, or time display, etc.
One or more heating or cooling elements or freeze or overheating protection components.
One or more sound or music or directions or instructions or safety guidelines, etc.
One or more ON/OFF indicators similar to nozzle color or not and/or with different components.
One or more motion-activated components or sensors or locks or security functions.
One or more spring-loaded features.
Ornamentation touches one or more nozzle areas with or without leaving open space.
One or more nozzle or component manufactured and sold with a product name or number or product line name or brand name or company name or logo or patent(s) pending or patent number(s) on the product itself in any form by itself. And, all of the above with the exception of company name or logo for any kit form.
One or more nozzle with a stop mechanism sold separately from balloons or anything else.
One or more nozzle with a see-thru body and a visible stop mechanism. This will allow children to understand the fluid and mechanical dynamics at work as well as watch any objects being inserted. The stop mechanism could be see-thru too of a similar or different material.
One or more nozzle could have one or more chambers that could be filled or not and one or more could even be see-thru to watch objects move around such as small plastic fish or balls that could be removable or not.
Threading designed for repeated use.
One or more nozzle or accessories advertised, promoted, or packaged with or as a storage means.
One or more nozzle sold in tamper-proof packaging or packaging that allows the user to test the main feature or features of the nozzle.
One or more ornamental feature could serve as one or more ingress, egress, conduit, stop or valve, balloon stop or guide or holding means, balloon accessory, or moving part or other means.
One or more nozzle or component made with a one or two or multi-shot injection process or with one or more overmold process with the same or different materials all or in part.
One or more nozzle or component made with one or more insert molding process with the same or different materials all or in part.

Kits and Displays:
One or more nozzle or components sold with or for non-balloon toys or toy pools or inflatable pools or larger pools.
Various kit versions including multiple nozzles of the same of different types.
Toy water sprinklers marketed for use with water balloons and/or as a kit with water balloons and/or nozzles and/or other accessories.
Any retail display for or including an ornamental water balloon nozzle and/or a preferred nozzle design of this invention.

Filling, Sealing and Tying:
Nozzles or components or accessories that seal the balloon with a device or adhesive or glue, etc or object. The gripping area can be for this or another area built into the nozzle. It can be disposable or have changeable adhesive qualities or a separate area to apply the adhesive or even a separate station.
Adhesives can be part of a kit or packaged separately or even have a tube held in the mouth or on the wrist or finger or other body part or belt or clothing, etc.
Nozzles that are designed as one-way shaft balloon holders. Harder to get on than off and requires more than the weight of a water-filled balloon to activate.
New designs for attaching water balloon clips to water balloons such as an integrated or separate station.
A filling funnel or nozzle with a flexible material to pull on/off of faucet or hose bib or a means to attach to securely hold and release as needed such as clips or snap on adaptor.
A nozzle designed to access the hose bib shutoff.
Any non-standard sized nozzle threading or without threading.
Snap on nozzles or adding on or inclusion of accessory to do that or an adjustable or rotating threading feature which enables installation and removal of the unit without rotating the entire unit, but instead only the attachment/detachment component.
An adhesive product that has a quick dry feature either part of the nozzle or a nozzle accessory or was a separate accessory or station or was a separate unit such as a glue bottle that could be handheld or attached to any object, body part, or clothing, etc.
A preferred adhesive product would be an accessory that could be attached between the nozzle and the hose or integrated with the nozzle. This may be changeable, refillable, cleanable, not easily clogged, have an opening and closing mechanism, and have an adhesive insertion spot and a delivery spot. Units could be sold separately and adhesive refills could be purchased as well. The user after filling the balloon can simply touch on the delivery spot the balloon neck or opening or inside of the balloon and pinch or fold and pinch or twist or grind, or flatten, or any combination which effectively closes the balloon. The adhesive should work well with latex and other balloon substances and be safe for humans and animals and preferably biodegradable as are many latex balloons. Informational suggestions for maintenance and use of the adhesive unit and for personal care can be included with the unit or provided by another means. A preferred means of dispensing could be through an orifice or a separate attachable/changeable tip that would help prevent clogging. A cap can be provided to cover the tip area to prevent premature drying. With the tip feature, the unit may or may not need a separate adhesive insertion spot. Another means of closure could be a device which performs this function either part of the unit or separate or any other tool or suitable implement or machine.
Inserted adhesive or other objects could be anything that fits in a dispenser or is water-soluble or water-activated or dispersed by the object put into the system. It may also not require a dispenser, but placement in or around the nozzle or component.
A longer nozzle or system which can hold and use a new type of water balloon clip. It can have interchangeable cartridges or other means for quick reloading. The new type of water balloon clip will have a wider middle section to slide through the cartridge and over the filled water balloon so that it may be easily tied with the provided slots which could be in any suitable location. The clips are preferably made out of a safe material such as foam. The clips may actually be something more flexible such as ribbon or even latex material itself with the advantage of less volume to manufacture and greater flexibility in use and design. The flexible material may be in the form of a knot to allow the user to simply pull or otherwise tie the balloon. The cartridge mechanism can attach by any means including a snap on means and even contain the fluid conduit and/or dispensing orifice for maximum design efficiency.
Balloon nozzles or accessories that have a feature or features to help the user maintain the proper placement of the balloon during the filling process. This could be something that holds the rim, the neck, a side or sides, or the base of the balloon or any combination. It could be in conjunction with a balloon tying device or not or other accessories or not.
A nozzle designed to minimize water use or wasted water.
A nozzle can have its own stand or support structure either integrated or as an accessory for increased portability.
Software to manufacture, order, sell, or market or customization capabilities.
Machines or molds to make system or components of the system.
Braille instructions or attachments.
One or more manufacturing mandrel or mold or nozzle with a recycling symbol and/or a resin identification code from the Society of the Plastics Industry (SPI).
A nozzle or accessory which may or may not meet or exceed ASTM D3901 and Green Seal GC-2 standards or future standards for the EPA recommended recovered materials content levels.
A nozzle or accessory which specifies the percentage of recycled content and/or pre-consumer or post-consumer waste content.
Packaged or sold as part of a set or collectible series of one or more styles or themes.
One or more indicators for balloon sizing or means to place a balloon on a nozzle component or shaft.
Ergonomic tabs or handles or tightening/loosening features or on/off source features.
Capability to adjust source volume for different sized balloons or objects. For example, filling up a large water gun.
One or more nozzle that grabs or holds the water balloon and fills it up and/or releases it.

Other Physical Properties or Variations:
A nozzle where the exterior is different or substantially different on one or more profiles, views, or angles.
A nozzle where one or more interior or exterior surfaces comprise a non-valve cavity or change the planar surface either inward or outward.
A nozzle with one or more non-valve moving part.
A nozzle where all or part of the fluid or object ingresses and egresses on one or more different planes or angles.
A nozzle or accessory designed to be used by one hand while attaching, holding, filling, removing, and/or sealing the water balloon or other object.
A nozzle advertised, promoted, and packaged as user-operable by one hand, or without touching, or one-touch, or one press, or one push, or one twist, or by other similar means.
A valve-type nozzle with an internal stop mechanism or where a stop mechanism is not visible on the exterior of the nozzle.
A nozzle actuated by the force of placing the water balloon or object on the nozzle.
A nozzle that does not require the user to press or pull a button or turn a handle or push a stop pin through the unit or to use another shutoff valve or the source shutoff valve in order to engage the stop feature or turn the source on/off.
A system that allows a user to fill up two water balloons at once without assistance from another individual, with one balloon in each hand. It could be separate nozzles, a two nozzle system, or part of a larger system. The user may or may not require assistance in tying the balloons depending on the sealing method or accessories used.
A nozzle with a multi-cone or multi-shaft or multi-section feature.
A nozzle with more than one seal device or more than one seal device along the same conical axis, one or more of which can be replaceable or not with a removal/replacement feature designed into one or more components.
A nozzle with a substantially lengthwise stem or plunger feature or a substantially perpendicular stem or plunger guide feature or more than one of these features in any configuration.
A nozzle where the cones or sections seal against each other frictionally or with an intermediary means.
A nozzle which may be pressed toward the water source (not necessarily the water which is in the system) to activate the system and pulled or just simply relaxed to deactivate the system.
A nozzle which may be twisted or turned to actuate the system and twisted or turned back to deactivate the system.
A nozzle with a conically engaged actuation feature.
A nozzle with a conically engaged actuation feature that is adapted to (using threads) engage a male hose fitting or female hose fitting or faucet or hose bib or threads to another size fitting or attaches without a threading means.
A nozzle with a conically engaged actuation feature that has a series of frustoconical sections of increasing diameter on the conical section.
A nozzle with a conically engaged activation feature that is designed to frictionally engage a water balloon or water toy.
A nozzle that is engaged and disengaged without user physical contact with a valve spool or part of a valve spool or may be engaged and disengaged without contacting a valve.
A nozzle that can be engaged and disengaged without user physical contact with the nozzle or any component part of the nozzle. A user may simply hold the balloon onto the nozzle and remove it as desired.
A nozzle with a conically engaged actuation feature with no washers, one washer, or more than one washer and/or other sealing means.
A nozzle with a conically engaged activation feature with words or letters or symbols or directions on the system and/or on/off indication features.
A nozzle where both a conical section and a valve or valve spool can move at the same time.
A nozzle where the egress can selectively move or change positions.
A nozzle where the valve or valve spool is solid or hollow or partly solid and partly hollow.
A nozzle where the valve or valve spool is or is not retained in the system by a pin.
A nozzle where the valve or valve spool is retained in the system by a plunger mechanism.
A nozzle where the valve and/or valve spool and/or valve pin is not visible or where the valve pin is not located at or near the ingress and/or a seal device.
A nozzle where the closed position is achieved by releasing the external pressure on the nozzle or by pulling off the water balloon or object while also releasing the external pressure.
A nozzle where the closed position is achieved by releasing the external pressure on the egress or conical section or other section.
A nozzle where the z-axis is the primary means or substantially the primary means of engaging and disengaging the system. All prior art nozzles now use either the x-axis, y-axis, or have no valve feature.
A nozzle with or without a stop that has one or more conical or substantially circular surfaces that is not substantially conical or circular.
A nozzle in which fluid flows into non-critical areas of the nozzle.
A nozzle where fluid pressure is not only sent through a valve or a cylindrical section, but to or potentially to other areas.
A nozzle where a valve can be taken apart, assembled, reassembled, maintained, updated, changed, and other means.
A nozzle where fluid flows through a series of ported openings not necessarily related to the ingress and/or valve.
A nozzle comprised of more than one cylinder or cylindrical section.
A nozzle comprised of more than one fluid compartment or section prior to the valve and/or after the valve.
A conduit with a variable cross-sectional area in which a fluid moves.
Any types of nozzles, valves, or tubes, including high speed nozzles, de Laval nozzles, convergent-divergent nozzles, magnetic nozzles, Venturi tubes, UV stabilized valves, PVC valves, polypropylene valves, automatic valves, manual valves, inflators, with recycled material, with seals, with O-rings, with U-cups, with diaphragms, or with plastic body, for example, to be used for water bombs, water rockets, and water cannonballs.

Other Non-Water Balloon Embodiments:
Tire nozzle or other nozzle caps that are ornamental or have other features.
Air or helium or mixed gas balloon inflation equipment especially ornamental versions and especially sports ball inflation nozzles or needles.
Air or foot pumps for balls and tires especially with ornamental versions.
Gardening accessories especially for nozzles and lawn ornaments.
Bottle accessories especially for office supplies (such as glue) and cleaning supplies.
For water purification systems or vanity or sink or utility faucets or bathtub or showerhead faucets or covers for these especially ornamental versions for children or for themes such as holidays or information conveyance. Most of these products are purchased by adults and are designed to be permanent fixtures or long-term interchangeable. However, having ornamental vanity faucets or faucet covers may encourage children to brush their teeth or help prevent germs to spread. These could be used in functional or informative versions in public places or hospitals for the same purposes or even for advertisement. For themes such as birthdays, sports, religious events, or holidays, these could be added. These could be for the nozzle itself, a replacement, add-on, or the same for the stop mechanisms such as covers for handles or for any part of the shafts or connecting parts. Dispensing mechanisms to store one of more of these can be placed in homes, hospitals, or public places either where electronic sensors are not activated or even where they are installed. That way, they can be utilized in bulk if necessary and disposed of. Of course, some versions can be reused and cleaned, etc.
Bubble and bubble bath dispensers that can be attached or added, etc. See previous.
Or, object dispensers for baths or sinks for kids, entertainment, educational, or functional purposes, or any other purpose. For example, dispensing small floating or non-floating toys in the tub when the faucet is engaged.

An adaptor for any off-the-shelf dispenser such as a device to encourage children to wash hands or for holiday themes, etc. which can be removed or replaced at any time. This enables the purchase of standard products at a lower cost perhaps while obtaining the benefit of the additional desired add-on feature.
Toys that mimic professional products, but are designed for consumer use such as a fire nozzle adaptor for a garden hose.

The shape of the figurine on the nozzle or hose can be that of a snake, fish, dolphin, or shark, that can swivel, snap in/out/on, located above/behind hose bib, attached, or glued, as an extension, flexible, or cover, with a foot pump, display, or kit. The balloon sealing can be done by glue, applicator, mixed chemical reacting upon exposure to each other, one chemical already deposited on tip of the balloon, gripper, or integrated in there, with balloon clip dispenser, balloon slot, with ads, or with size and glue type color coded or marked or written on it. They can be fitted in a nice packaging for display/sale.

For the nozzle, one can have a spool or stop device, with push/pull mechanism, twist-tip design, nozzle with grading tip for different size balloons, or variable/gradual groove. It can be monitored electronically, by weight or size or pressure sensors, to stop the filling. It can have different variations on the top, e.g. spring-loaded, press-around mechanism, by fingers, with the external piece starting the pump to fill the fluid in the balloon. To start the pump, the switch can be a single switch under the nozzle, which can be turned on/off, using pressure. Objects or marbles or bubbles or oil particles or plastic pieces or metallic pieces can float in the fluid, with transparent jacket, or the eyes of a character is moving with the water flow, for kids, with see-through features (for example, for nozzles or garden hose), with the pieces of ornament or toys exchangeable, with the color filters to change the color of objects, for entertainment, for kids.

It can be set up in a backpack, hydration system, with a nozzle, with filter and portable water container. It can be used for tire nozzle/caps/ornament. It can be used for the inflation needles/pumps. It can be used for bath tub, for kids/play, for faucet or handle, or educational toy, e.g. for fire hose. It can be used for home dispenser systems and retail displays.

Here is the description of one type of the nozzle: The bottom cone is connected to a hose, and the top cone is attached to a shaft and plunger. When the top cone is depressed, it will open the plunger, allowing the flow. In other places, they are sealed to avoid the leakage. The cone is barbed to secure the balloon. The plunger seals against the bottom piece using an O-ring. The dimensions could be designed to change the flow rate. The upper cone also has an interior lip for sealing purpose.

Other Variations of the Above Design:
The twisting plus the thread can be used instead of pushing mechanism.
The holes can be added, where upon alignment the flow can be done.
In addition, instead of pushing, one can open by pulling, to separate the upper portion/cone from the lower portion/cone.

Other embodiments could include a tether with a balloon disc, clip, or cup attached. Any balloon disc, clip, or cup could be used. The tether could also be integral and continuous with the balloon itself, so that the balloon and the tether are manufactured together.

The invention includes the use of any type of balloon. This includes latex balloons, water balloons, punch balloons, helium balloons, foil balloon, nylon balloons and Mylar balloons.

Another embodiment includes balloons manufactured with an attachment point for the tether. The attachment point could be a balloon disk manufactured around the neck of the balloon. Alternatively, the balloon could have a knob or loop manufactured into the balloon, creating an attachment point.

The connection means can be by any method, such as tied rope, ribbon, string, glued, hinge, metal joint, welded, sewed, solid, rigid, or flexible, and made of any material, such as rubber band, silk string, wool, metal chain, plastic chain, rigid, flexible, or soft material.

Note that tether's equivalent terms (or other connecting methods/devices) can also be used here, such as cord, chain, fastening device, rope, thread, fibrous material, confining device, string (cotton, nylon, or any other material), belt, tape, tie, attaching device, lace, Velcro fastener, hook-and-loop fastener, band, strap, snap, wire, cable, elastic, glued material, holder, disk, cup, clip, pull tabs, knot, adhesive, and connector.

The tether can have multiple components, made of many parts, in series or in parallel configuration, such as chain of cotton and nylon strings tied together.

The balloons can be of any kind of balloons in the market, such as water balloons, Helium balloons, or air balloons, made of any type of material, and closed off by any method, at the factory or by the user.

Tether can be made of any material, such as rubber band, string, wool, silk, solid, plastic, elastic, soft, rigid, flexible, adjustable size, fixed size, or multi-threaded material. It can be a hook or a tie. The tie can be closed up by the user to close off the balloon, to keep air or water inside the balloon. In one embodiment, the loose tie is pre-manufactured at the factory to make it easier for the user to fill up, tie up (e.g. pull tabs of a slipknot), and set up the balloons. It can have multiple pieces, and can be made of any fastening method or technology. It can be an integral part of another, such as a slipknot configuration. It can be 1-piece, 2-piece, or 3-piece setup.

It can be of any shape and material, as long as it can keep or hold the water or air inside the balloon. Examples of material are plastic, rubber, and metal pieces. Any other logical combinations or variations of these are also meant to be covered under this patent disclosure, e.g. magnetic material (magnets), coupled to each other. The knot can be of any shape (or any type of knot).

In one embodiment, one puts a string (or hook, ribbon, or any fastening tool or device) inside the lip (tip) of the balloon so that the user has an easier time to close off the balloon. This can be pre-manufactured at the factory.

In one embodiment, the balloon device with the balloon manufactured in such a way that it has an attachment point for ease of attachment or closing the balloon. The weight can be used as/for/together with/instead of an anchor, display, balloon bar, set-in-the-ground, attached-to-a-bag, pin, tent peg, spike, spike with a base (for sandy areas, to bury the flat base, for support of the spike), balloon barb, or decoration purposes.

Any parts of the setup explained above can be sold or packaged as a kit, so that the user can put them together, using an instruction manual. They can be all or partially in one package, with the adhesive material included, as an option.

The kits can also include (or not include) software, CD-ROM, DVD, VCR, tapes, or tape cassettes, in addition to (or not including) the booklets and other accessories.

This system can be included in a retail packaging and/or retail displays (counter, floor, shelf, etc.). The kit or packaging includes various parts or components which can be put together by the user, which can be sold separately or altogether. It can include balloon markers and other accessories.

This software can offer setup, management, and cleanup tips, as well as multiple game and activity listings. Additionally, it can offer printable and/or E-mail versions, as well as a database to add user developed ideas and notes. It can also provide tools to manage events and setup crews, as well as tools and templates to design event layouts. It can even be integrated with existing recreation program, sports management, facilities management, or tournament scheduling or party or event planning or educational programs. The software can also describe and provide tools on how to incorporate ideas into for profit or not-for-profit businesses.

In one embodiment, the balloon is held using a securing means such as a net. The securing means can be any type or securing means. The securing means can be made out of cloth, fabric, string, plastic, wire, or any type of material suitable to secure the balloon. The size of the securing means is any size that can hold a balloon. The securing means needs to be only as large as the desired balloon. The balloon fastener can be any kind of balloon fastener. Possible balloon fasteners include slipknots, knots, a net, a balloon disc, a balloon clip, a balloon cup, or an attachment point on a balloon. Alternatively, balloon fastener could be integral and continuous with the balloon and tether, for example, when balloon and tether are manufactured together. Possible attachment point versions of balloon fastener include a projection or loop that is integral and continuous with the balloon that the tether can be tied to. These projections or loop would be manufactured as part of balloon. The slipknot version of balloon fastener could include zero, one, or two (or even more than 2) pull tabs.

The balloon can be attached or separate from the tether. The balloon can be filled or unfilled. In one embodiment, the balloon is unfilled and not attached to the tether. A person using the device would fill the balloon and then attach the balloon to the tether using the balloon fastener. The balloon fastener can also seal the balloon. In another embodiment, the balloon is filled and is not attached to the tether. The person using the balloon game kit would attach the balloon to the tether using the balloon fastener. In another embodiment, the balloon is unfilled, but is attached to the tether. In this case, the person using the balloon game device would fill the balloon and then seal the balloon using the balloon fastener. In one embodiment, the balloon is both filled and attached to the tether.

The disk and cup can be used for attaching a string (or ribbon or similar connecting or attaching means) to a balloon. In one embodiment, the balloon has a hole prefabricated in its elastic enclosure, through which a string or rope can go, for the purpose of attaching another object to a balloon. The strap for the attachment to the balloon may be adjustable. Multiple balloons (sometimes, with different material/content (different gas/liquid contents) or different shapes) may be attached to one or both ankles (or other body parts, or still/moving objects), through one or more connections or strings.

The weight/closure/an object can be connected to a balloon/second object, for example, using tape, ribbon, staples, or clip (with (or through) a hole, for example). The objects can be inflatable toys, stuffed animal toys, dolls, or objects-glowing-in-dark.

Any variations of the above will also be included in the scope of the patent protection.

1. A nozzle, wherein said nozzle comprising:
a front section,
a back section, and
an ornamental object,
wherein said front section is connected to a filling object or filling reservoir, and said back section is connected to a fluid or material supply or reservoir.

2. A nozzle as recited in claim 1, wherein said fluid or material flows from said fluid or material supply or reservoir, through said back section and said front section, to said filling object or filling reservoir.

3. A nozzle as recited in claim 1, wherein said filling object or filling reservoir is one of more of the following: a balloon, water balloon, water toy, water-based object, toy, air-based object, gas-based object, fluid-based object, a filling object, an elastic object, or an expanding object.

4. A nozzle as recited in claim 1, wherein said fluid or material is gas, liquid, fluid, hot gas, powder, dust, solid, particles, bubbles, foam, sponge, gel, water, helium, hydrogen, oxygen, nitrogen, glass pieces, or optically reflective material.

5. A nozzle as recited in claim 1, wherein said fluid or material supply or reservoir is a tank, hose, hose bib, faucet, conduit, pipe, water supply station, water reservoir, pump, motor, fan, compressor, gas supply, supply line, manifold, valve, powder-maker, or pressurized tank.

6. A nozzle as recited in claim 1, wherein said nozzle is attached to a balloon, water balloon, toy, or object, by a gripping means, glue, rope, string, clip, adhesive, nozzle ridge, nozzle accessory, chain, tether, attaching means, tie, knot, tape, rubber band, band, elastic material, pressurized mechanism, metal ring, cable, wire, screw, nail, staple, groove, high-friction-type material, or spring-loaded material.

7. A nozzle as recited in claim 1, wherein said nozzle or nozzle accessory has multiple pieces in a kit format, packaging, display, or for separate sale.

8. A nozzle as recited in claim 1, wherein said nozzle is made of plastic, wood, metal, elastic material, synthetic material, soft material, solid material, natural material, rigid material, alloy, PVC, multiple components, molded material, glued material, water-resistant material, pressure-resistant material, sealed material, or layered material.

9. A nozzle as recited in claim 1, wherein said ornamental object comprises multiple pieces.

10. A nozzle as recited in claim 1, wherein said ornamental object can be changed.

11. A nozzle as recited in claim 1, wherein said ornamental object is permanently attached to said nozzle.

12. A nozzle as recited in claim 1, wherein said ornamental object has one or more functionalities.

13. A nozzle as recited in claim 1, wherein said ornamental object is used for one or more of the following functionalities: gripping, protection, cover, hanging, light protection, impact protection, temperature protection, pressure protection, handling, leveling, toy, education, educational, lifting, attaching, positioning, storage, accessory attachment, marketing, movement, filling, tying, dispensing, adjusting, light, warning, safety reminder, or marking.

14. A nozzle as recited in claim 1, wherein said ornamental object comprises an optical reflective material.

15. A nozzle as recited in claim 1, wherein said ornamental object comprises a light source or electronic device.

16. A nozzle as recited in claim 1, wherein said ornamental object is a handle.

17. A nozzle as recited in claim 1, wherein said ornamental object is a hook.

18. A nozzle as recited in claim 1, wherein said ornamental object is an extension part, accessory, or cover for said nozzle, a valve, or a pipe.

19. A nozzle as recited in claim 1, wherein said ornamental object is made of plastic, wood, metal, elastic material, synthetic material, soft material, solid material, natural material, rigid material, alloy, PVC, multiple components, molded material, glued material, water-resistant material, pressure-resistant material, sealed material, cotton, fabric, see-through, transparent, translucent, reflective, shiny, or layered material.

20. A nozzle as recited in claim 1, wherein said ornamental object is a tripod, support, leveling means, legs, or stand.

21. A water balloon nozzle, wherein said nozzle comprising:
a front section, and
a back section,
wherein the flow through said front section is not aligned with the flow through said back section.
